(19) United States
(12) Patent Application Publication
(10) Pub. No.: US 2021/0350784 A1
(43) Pub. Date: Nov. 11, 2021

(54) CORRECT PRONUNCIATION OF NAMES IN TEXT-TO-SPEECH SYNTHESIS

(71) Applicant: SoundHound, Inc., Santa Clara, CA (US)

(72) Inventor: Mara SELVAGGI, San Jose, CA (US)

(73) Assignee: SoundHound, Inc., Santa Clara, CA (US)

(21) Appl. No.: 17/314,732

(22) Filed: May 7, 2021

Related U.S. Application Data
(60) Provisional application No. 62/704,457, filed on May 11, 2020.

(51) Int. Cl. G10L 13/033; G10L 13/047; G10L 15/02

(52) U.S. Cl. CPC G10L 13/033; G10L 2015/025; G10L 15/02; G10L 13/047

(57) ABSTRACT

A personalized name pronunciation is generated by receiving a request from a client device associated with a person ID. A lexical representation of a name is obtained and pronunciation information for the name of is created based on an input from to the client device. The pronunciation information is stored with the lexical representation associated with the person ID in a database. A message request to provide a message that includes the name associated with the person ID may be received and a script obtained. The database is accessed using the person ID to obtain the pronunciation information for the name. Speech representing lexical text of the script is synthesized and an audio representation of the name is generated based on the pronunciation information. The speech and the audio representation of the name are delivered to at least one individual as audio.

### CROSS-REFERENCE TO RELATED APPLICATIONS

This application claims the benefit of U.S. Provisional Application 62/704,457, filed May 11, 2020, which is hereby incorporated by reference in its entirety herein for any and all purposes.

### TECHNICAL FIELD

The present subject matter relates to phonetic representation of names and synthesis of speech audio based on such representations.

### BACKGROUND

In 1910, the Automatic Electric Company of Chicago produced the first electronic public address (PA) system. Such systems allow an operator to speak into a microphone and have their voice projected from one or more loudspeakers in public spaces. This allows the operator to give messages to all people who can hear the loudspeakers or even address a single person by name.

More recently, some automated PA systems that provide prerecorded messages with relevant current information have come into use. An example is a PA system in a subway station that announces the amount of time until the next train arrives. The purpose of such PA systems is to address all people who can hear the loudspeaker, not any particular person.

In modern times, places such as the United States of America and countries within the European Union have fast-growing numbers of people from all over the world using services such as airports, airplanes, train stations, hospitals, self-service health care portals, hotels, factories, offices, and other facilities where they may enroll, check in, or otherwise register their presence in a way that identifies them by name. Many such people have lexical (written) names that correspond to their spoken names according to varying systems of phonetic representation. For example, the phonetic pronunciations of written Irish words are quite different from those of English words even though England and Ireland are neighboring countries. As a result, many English speakers do not know how to properly pronounce the Irish name Caoimhe.

If an operator of a PA system wants to address a person by name, but the operator is unfamiliar with the phonetic representation of the person's written name, the operator might say the name in such a way that the person does not recognize that they are being addressed. This can lead to missed airplane flights or trains, delayed doctor's appointments, inefficient business operations, and even serious risks to personal health and safety in factories and other workplaces when it is important to call a worker to handle a situation.

As people of the world become more integrated, and people from different ethnic backgrounds interact more and more, this is becoming an increasingly costly and important problem.

### BRIEF DESCRIPTION OF THE DRAWINGS

The accompanying drawings, which are incorporated in and constitute part of the specification, illustrate various embodiments. Together with the general description, the drawings serve to explain various principles. In the drawings:

FIG. 1 shows database fields appropriate for some embodiments;

FIG. 2 shows a travel gate desk appropriate for some embodiments;

FIG. 3 shows an amplifier appropriate for some embodiments;

FIG. 4A shows a bullhorn loudspeaker appropriate for some embodiments;

FIG. 4B shows a ceiling mounted loudspeaker appropriate for some embodiments;

FIG. 5 shows an administrator interface for adding announcements appropriate for some embodiments;

FIG. 6 shows a self-service health care system appropriate for some syst embodiments ems;

FIG. 7 shows an airline reservation system for receiving passenger information appropriate for some embodiments;

FIG. 8 shows an airline reservation system for recording passenger speech appropriate for some embodiments;

FIG. 9 shows phoneme recognition appropriate for some embodiments;

FIG. 10 shows an airline reservation system with an error response and request for new speech recording appropriate for some embodiments;

FIG. 11 shows an airline reservation system with pronunciations and generated speech synthesis of pronunciations appropriate for some embodiments;

FIG. 12 shows a networked system for a terminal interacting with the database server appropriate for some embodiments;

FIG. 13A shows a schematic diagram of a server system appropriate for some embodiments of a computerized system for personalizing a name pronunciation;

FIG. 13B shows a schematic diagram of a server system appropriate for some embodiments of a computerized system for delivering a message with personalized name pronunciation for a person associated with a person ID;

FIG. 14 is a flowchart of an embodiment of a method for personalization of name pronunciation;

FIG. 15 is a flowchart of an embodiment of a method for authenticating a user in a system for name pronunciation;

FIG. 16 is a flowchart of an embodiment of a method for creating pronunciation information;

FIG. 17 is a flowchart of an alternative embodiment of a method for creating pronunciation information;

FIG. 18 is a flowchart of another alternative embodiment of a method for creating pronunciation information;

FIG. 19 is a flowchart of an embodiment of a method for delivering a message with personalized name pronunciation; and

FIG. 20A shows a non-transitory computer readable medium appropriate for some embodiments;

FIG. 20B shows a non-transitory computer readable medium appropriate for some embodiments;

FIG. 21A shows a package system on chip appropriate for some embodiments;

FIG. 21B shows a block diagram of a system on chip appropriate for some embodiments;

FIG. 22A shows a rack-mounted server system appropriate for some embodiments; and

FIG. 22B shows a block diagram of a server system appropriate for some embodiments.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, and components have been described at a relatively high-level, without detail, in order to avoid unnecessarily obscuring aspects of the present concepts. A number of descriptive terms and phrases are used in describing the various embodiments of this disclosure. These descriptive terms and phrases are used to convey a generally agreed upon meaning to those skilled in the art unless a different definition is given in this specification.

The various examples of systems described below allow a system to use correct pronunciation of names in text-to-speech synthesis. A database stores pronunciations of people's names keyed to person identifiers. This can be, as non-limiting examples, a database of travelers in an airline reservation system, a database of bank customers, or a database of patients in a health care network. The database may also store the people's names in lexical characters, that is the characters normally used to write names.

The name pronunciations are requested and captured as part of an enrollment procedure such as, but not limited to, booking a trip, opening an account, or registering as a patient. Name pronunciations may be represented as audio recordings or phonetic text in a standard alphabet such as the international phonetic alphabet (IPA) or other language-specific codes such as the Carnegie Mellon University (CMU) English phoneme codes or other codes using characters whose pronunciations conform to conventions common in the language without requiring any special training. Enrollment systems may provide people with a way to speak their name through a microphone and then perform phoneme recognition on the speech audio. Enrollment systems may alternatively or additionally use the lexical spelling of a person's name to predict the most likely phoneme sequences for that person's preferred pronunciation. Enrollment systems may then provide people a menu of choices for their name written phonetically or available to be output through a loudspeaker as synthesized speech. That way, a person can conveniently choose their preferred pronunciation from a menu.

PA systems, telephone-based automated customer service systems, or other systems utilizing text-to-speech processing, can use the pronunciations from the database to address people using a pronunciation of their name that they will recognize. There are various ways to implement this. Some embodiments may show a PA system operator a phonetic representation of the name to read. Another is to have preset announcements with placeholders for a name. An operator may speak the name, or a text-to-speech synthesizer may synthesize speech audio for the announcement and the name based on the pronunciation from the database. The system may be automated so that an operator can pick the name from a list and an announcement from a list and request the announcement accordingly.

It is also possible to use correct pronunciations from a database in systems with a direct person to machine interface that is not public. Some examples are telehealth and telemedicine terminals, automated bank telephone interfaces for banking customers, or any other system for which people create accounts with profile information.

Various systems may solve the name pronunciation problem in environments such as airports, airplanes, train stations, hospitals, self-service health care portals, hotels, factories, offices, and other facilities, portals, and services that people use where they might be addressed by their name. Readers of languages that have unambiguous lexeme to pronunciation mappings, such as Korean and Italian, generally have no issues with ambiguous name pronunciations. However, names using traditional Chinese (also known as Kanji) characters may have different pronunciations in Japanese, Mandarin, and Cantonese. Furthermore, in countries that have a multiplicity of ethnicities, such as the United States, lexeme to pronunciation mappings are often difficult to infer.

### Databases

Large numbers of people or their agents may have registered their name pronunciations into a database. In some systems, they may register other information such as a given and family name in lexical text characters, an address of residence, a country of citizenship, and other profile information. Databases typically have a primary key, such as a person ID. The person ID could be a social security number (SSN) or other government-assigned identifier, a frequent traveler number, member number, patient number, or other type of unique identifier. The person ID may be the primary key to which other database records are keyed.

Name pronunciations may be stored in the database as speech recordings, such as ones made by people directly or their agents, guardians, partners, or others. This ensures that the pronunciation matches the person's preferred or easily recognized pronunciation. It can also be a simpler implementation than using computerized phonetic representations of pronunciations. Name pronunciation, however, may additionally or alternatively be represented in the database as phonetic text. This allows for a system to pronounce the name using the same text-to-speech synthesized voice as other words in computer-generated speech, which makes for a more natural-sounding synthesized sentence.

Various ways to represented pronunciations in phonetic text may be used, depending on the embodiment. Some embodiments may use a language-independent alphabet such as the international phonetic alphabet (IPA). This allows for simpler speech synthesizers that only need to understand one alphabet to ensure that the synthesized speech matches a name pronunciation with acceptable accuracy. Other embodiments may use language-specific alphabets such as CMU phoneme codes for English or machine-learned language-specific embeddings that represent pronunciations. This may allow for improved accuracy and naturalness of the sound of audio synthesized with name pronunciations. Alphabet or pronunciation embedding may be chosen for a particular person based on other information about the person in some embodiments, such selecting the representation based on a language preference or name origin information for the person.

Databases may be stored locally, such as one within a particular system, or remote, such as one in a cloud data center. Remote databases may be accessed by devices through networks such as the internet. Access to a remote database may use an encrypted connection. Databases may be controlled by the owner of a system for registering people, the owner of systems that use the data to provide synthesized spoken messages to people, or a third party. In some embodiments, a database storing the information about the person, including the name pronunciation information, may be relational, maintained by a database management system (DBMS), and accessed using a structured query language (SQL). Databases may be unitary or distributed such as with a Hadoop file system and programmed with MapReduce.

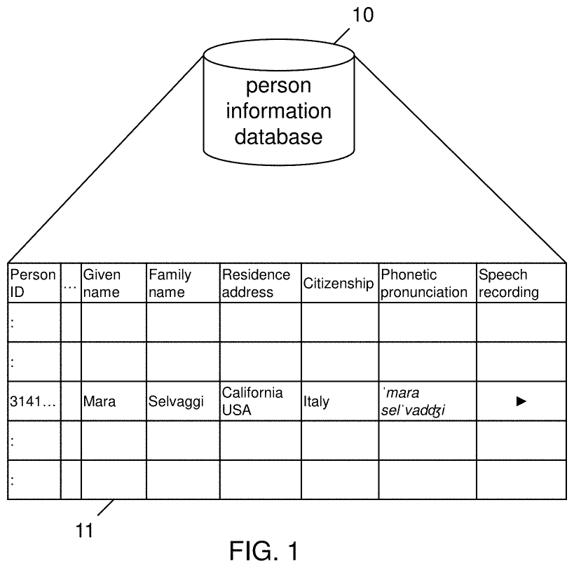

FIG. 1 shows a representation of a person information database 10 and a table 11 that represents records stored within the database, which may be suitable for some embodiments. The records are keyed to a Person ID field and include a given name, family name, residence address, citizenship, phonetic pronunciation of a preferred name, and a speech recording of a person speaking the preferred name, among other possible information which may vary depending on the embodiment. Depending on the application, databases may have any number of records ranging from only a few records to millions of records or more of people's personal information. Some systems may allow an operator to access filtered lists of people in the database, where the filter may provide only records for people meeting the filter criteria, such as, but not limited to, people scheduled for an airplane flight, people checked in to a hospital waiting area, employees badged in to an office building, or children in a particular classroom within an ethnically diverse school where a principal may want to call a student to the main office but cannot know the preferred pronunciation of every student's name.

PA systems

Some embodiments may function as a computerized PA system that includes a database interface enabled to read, from a person information database, a name pronunciation keyed to a person ID, an operator interface allowing an operator to make an automated announcement by selecting both the person ID from a filtered list of database records and an announcement stored as lexical text having a name placeholder. A speech synthesizer may then be used to create audio with the name pronunciation of the person ID in the place of the name placeholder which may then be sent to a loudspeaker. Thus, the name pronunciation used by the PA system was specified by the person identified by the person ID.

Such PA systems are often found, for example, in waiting areas, such as at airports, train stations or hospitals, or other places within the same building as a person to be addressed. The database interface may be through a wired connection, such as an Ethernet network, or a wireless connection, such as WiFi® network, to a server that hosts the database. The interface may pass through one or more routers and/or intermediate servers or computers to perform reads of name pronunciations.

In some embodiments, an administrator may prepare a set of frequent types of announcements. By allowing an operator to simply select a prepared announcement and one or more names from the database, it is simple for the operator to cause appropriate announcements and natural for people to recognize when the announcement addresses them. This both improves the effectiveness of announcements and the ease of making the announcements.

In case a person information database has no name pronunciation entry for the selected person, embodiments may synthesize speech audio for the name according to a set of default lexeme to phoneme rules for pronunciation of characters in a lexical representation of the name stored in the database record keyed to the person ID. Such rules are commonly a part of text-to-speech systems for general speech. Embodiments may, also or instead, allow for an operator to speak the person's name to be included with the announcement. This is possible if the system shows the operator the name in a phonetic representation that the operator can understand. It is also possible by simply showing the operator a lexical representation of the name, which they can use to pronounce the name as their life experience has taught them.

In some embodiments, system administrators can use an administrator interface to define announcements as lexical text having placeholders for person names. This allows for customization of a system with announcements that are known to be effective in synthesized voices with widely recognizable accents and voices in order to be most clearly understood, while also allowing for the system to include correctly pronounced names within announcements.

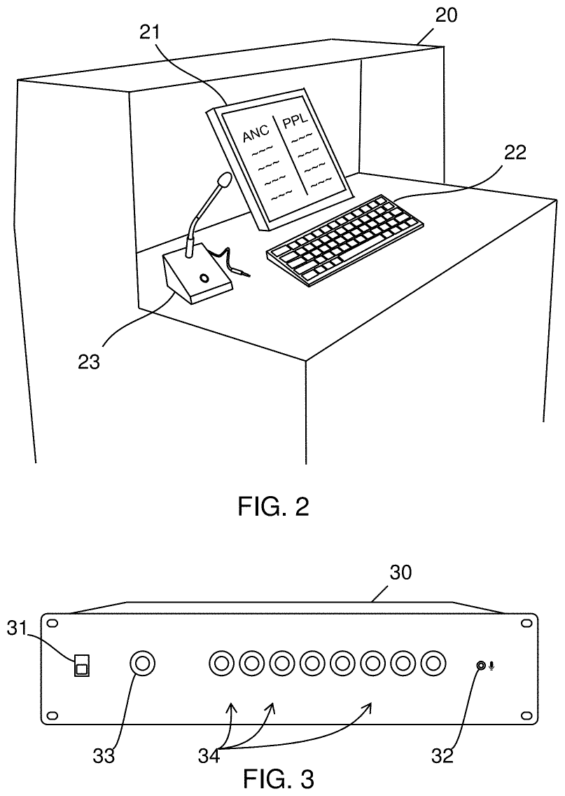

FIG. 2 shows an example operator interface for a PA system. It is a type that may be found in an airport gate waiting area. It comprises a desk 20 with a display screen 21 oriented for the operator, such as a gate agent, to easily read information. The operator can control the PA system by input through a keyboard 22. Other systems may use a mouse, touch screen, voice interface, or other input methods for controlling computerized systems.

The display screen 21 shows a list of preset announcements and a list of people ticketed for a flight. The list of ticketed people is filtered from a database of all known travelers. Another example of filtering is a list of checked-in patients at a hospital from a database of all healthcare system members.

The PA system of FIG. 2 further includes a microphone device 23 with a push-to-talk (PTT) button and a plug to send speech audio to an amplifier. The microphone 23 can be used for custom messages in case a situation arises in which a gate agent needs to make an announcement that is not on a preset list.

FIG. 3 shows an amplifier 30. It has a power switch 31. When powered on, it can receive analog or digital audio signals from a source, such as a computer terminal or microphone, and send higher-powered sound signals to speakers. The amplifier has a jack 32 for receiving an analog signal from a microphone. The amplifier has a master volume control 33 that enables a system administrator to easily adjust the volume of sound at all speakers simultaneously. The amplifier 30 also has separate volume controls 34 with one for each of 8 speakers. This allows a system administrator to adjust the volume of each speaker individually to make announcements sufficiently but not uncomfortably loud in different parts of the public space.

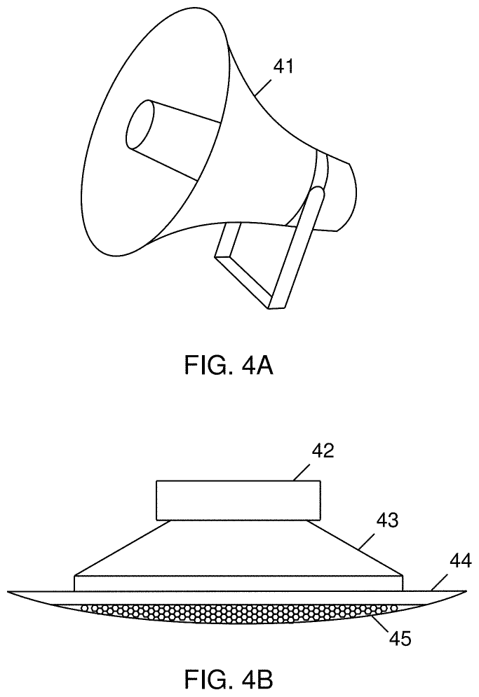

FIG. 4A shows a bullhorn style loudspeaker 41. It may be mounted on a wall or ceiling and provide a loud, directional audio signal. Bullhorn loudspeakers are commonly useful in outdoor environments or buildings with high ceilings such as factories, warehouses, or stadiums.

FIG. 4B shows a loudspeaker for mounting within ceiling panels. It comprises a magnet 42 that drives wires in a cone-shaped diaphragm 43 to cause vibrations in air at audible frequencies. The speaker has a suspension ring 44 for sealing the speaker to a hole in a ceiling tile and a protective metal mesh screen 45. Such a loudspeaker is useful in smaller spaces with relatively low ceilings such as office spaces, schools, and some airport waiting areas. A PA system will typically have more than one such loudspeaker.

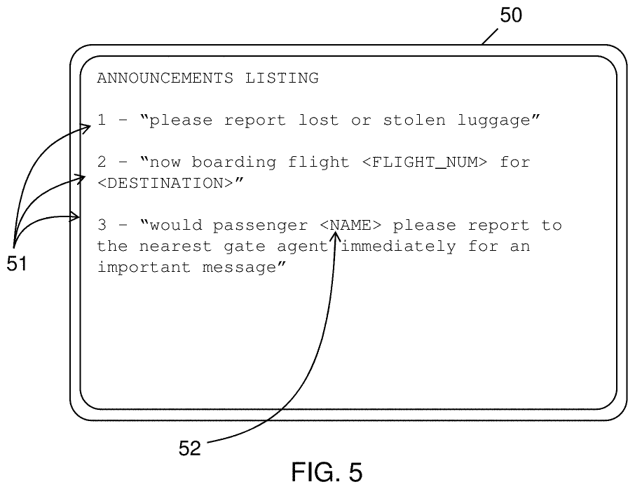

FIG. 5 shows an embodiment of a system administrator interface 50 for viewing and editing predefined announcements 51. The announcements are defined as text. Each announcement may have a unique number. These are used to display a list of the predefined announcements on the operator display. Announcement text may comprise placeholders, indicated by placeholder names within angle brackets. Some example placeholders are a flight number, <FLIGHT_NUM>, and a destination city, <DESTINATION>. The operator interface allows the operator to enter or select a flight number and destination city when the operator requests the broadcast of an announcement with such fields. Similarly, a placeholder <NAME>52 is a placeholder that identifies a space within an announcement for a preferred name pronunciation. When an operator requests an announcement with a <NAME>placeholder, the system provides a list of people's names. The operator may select a name, after which the PA system makes the announcement using text-to-speech (TTS), outputting the person's preferred name pronunciation at the specified location within the announcement text.

### Self-Service Systems

Though some embodiments are useful for public address, others are useful for direct interaction between a person and a machine that speaks the person's name. Some such embodiments receive requests associated with person IDs and read, from a person information database, name pronunciations keyed to the person ID. They may also read, from scripts, sentences having name placeholders and synthesize speech audio corresponding to the sentences with the name pronunciations in the place of the name placeholders. The synthesized speech may then be output to one or more loudspeakers. In such embodiments, the name pronunciations may have been specified by the people identified by the person IDs.

This can be useful in, for example, personalized healthcare systems available within hospitals, clinics, or devices within homes. It is also useful for government services, such as receiving applications for social benefits. It is also useful for travel check-in or other service interfaces, such as at terminals within airports or train stations or hotel check-in desks. It may also be useful for voicemail messages to allow a voicemail system to generate prompts with proper pronunciation of the mailbox owner's name. It can also be useful for self-service interfaces for online educational services, and retail services, such as interactive voice response (IVR) automated banking. Some banking services already store databases of spoken names for voice fingerprint authentication which may also be usable for creating pronunciation information.

Having a speech interface with a person's preferred name pronunciation makes the customer experience more satisfying, which may increase the frequency of return customers. It also may increase the effectiveness of interactions with customers and encourage them to stay engaged longer with the provider's services. Many health information systems today already have a language preference field for health system members which may be used as a hint for name pronunciation. Thus, the language preference can guide the selection of a most likely pronunciation of a lexical name if the database does not include a preferred pronunciation.

Self-service systems generally require a person to log in by entering a username and password tuple. The system may then authenticate the username and password and begin a session associated with an account associated with the username/password tuple. The account may be associated with a record stored in a database as shown in FIG. 1. The person ID may be used as the database key for accessing the database may be stored with profile information associated with the username. The session may operate programmatically using a script. The script indicates how to proceed in response to user input. When the script instructs the system to proceed in a way that speaks a sentence to the person where the sentence includes a name placeholder, the system may use the name pronunciation associated with that person ID. The system may read the name pronunciation from the database as needed for sentences having a name placeholder, or may read the name pronunciation near the beginning of a session and store it to use for any sentences with name placeholders until the session ends. After the end of a session, the system disregards its stored pronunciation and repeats the process whenever a new login happens.

Since name pronunciations are personal information, it is important for legal compliance that systems comply with legal standards such as the US Health Insurance Portability and Accountability Act (HIPAA) or the European General Data Protection Regulations (GDPR). Accordingly, such systems must perform an authentication of the user in compliance with the regulations. This has a benefit for compliance in that a human service agent does not need to be involved in rudimentary patient interactions, which improves the preservation of privacy.

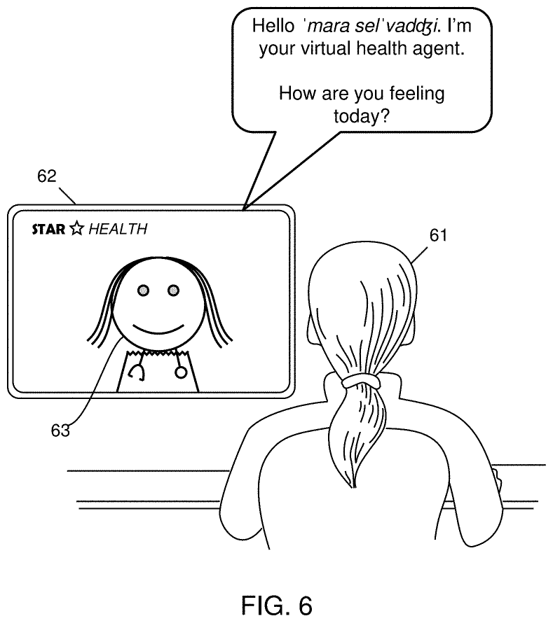

FIG. 6 shows an interactive telemedicine system and a patient interaction. Patient 61 interacts with display terminal 62. The display terminal shows an animation of a doctor 63. The terminal 62 synthesizes and output speech in the voice of a doctor saying “Hello ‘mara sel’vadd [symbol] i. I'm your virtual health agent. How are you feeling today?” The speech output uses the preferred pronunciation of the patent's name, ‘mara sel’vadd [symbol] i.

### Enrollment Process

In systems that are able to output synthesized speech audio with people's preferred pronunciations, a database may be used to store that pronunciation information. Single systems or separate systems using an agreed database format may enroll people in the database by receiving, from people, a lexical text entry of their name; receiving, from the people, pronunciations of their names; and storing the lexical text entry and the pronunciations in the database keyed to a person ID. This may also be referred to as personalizing a name pronunciation, which may include receiving a request from a client device used by a person and associating the person with a person ID. A lexical representation of a name of the person may be obtained and pronunciation information for the name of the person, different than the lexical representation of the name, may be determined based on an input from the person to the client device. The pronunciation information may then be stored with the lexical representation of the name associated with the person ID in a database.

Such methods provide pronunciation information used by systems that synthesize speech with correct name pronunciations directly for people. As a result, one system provider may pay another or the people using the systems may pay for their services. Some non-limiting examples are travel reservation systems such as ones for airplane flights, train trips, or hotel stays. Other non-limiting examples are healthcare system enrollments, enrollments in educational institutions, or any system that includes people opening accounts such as banks, online shopping web sites, or email services.

Some systems may allow people to skip entering a preferred pronunciation of their name. Some people may choose this to protect their privacy, especially if their name has a very distinctive pronunciation. Some systems may, if no match is found or if a person chooses not to provide a preferred pronunciation of their name, store a pronunciation according to a set of default lexeme to phoneme rules or using a dictionary lookup. This can ensure that every database record includes a likely-preferred name pronunciation so that systems that later read from the database can use the pronunciation without having to implement their own methods for guessing at preferred pronunciations. In some systems, a pronunciation hint associated with the person may be obtained and used with the lexical representation of the name to generate pronunciation information. In at least one embodiment, a geographic identifier for the person may be used to choose a dictionary to use to select a pronunciation for their name. In another embodiment, a language preference may be used to select a set of lexeme to phoneme rules used to generate pronunciation information. Any type of pronunciation hint may be used, depending on the embodiment, but non-limiting examples include a geographic identifier such as a country name, an ethnic group, a religious preference, a gender, and a language associated with the person.

When a person enrolls in a system, such as by buying an airline ticket, signing-up with a healthcare system, or setting up security when opening a bank account, a system may ask the passenger, patient, or customer (“person”) how to pronounce their name. The request for a name may be by speaking into a microphone, selecting from a menu of pronunciations, or entering phonetic text. This can be done through a web browser or phone app that presents a microphone button, a selection box, or a text entry box. Some systems may also or alternatively accept entry of lexical text as a spoken spelling of letters and pronunciations as speech through voice interfaces. People may enter their own information or somebody else may enter the information on their behalf. For example, a parent may enter the information for a child, a travel agent may enter information for a customer, or clinic front desk registration staff may enter information for a new patient.

Enrollment may be performed on a single computer, where the person is interacting with user input devices of that computer to update a database stored on that computer, but in many embodiments, a client/server architecture may be used with multiple computers to enroll the person. In some embodiments, a user may interact with a client device, such as a desktop computer, laptop computer, tablet, or smartphone, which communicates over a network with a server computer. The client device may run a local app to perform preset functions that communicate with another program running on the server. Alternatively, the client device may run a browser that communicates using standard world wide web protocols such as hyper-text markup language (HTML) documents sent using a hyper-text transport protocol (HTTP) provided by a sever running a standard web server such as Apache® HTTP Server. The server may manage the database itself or may communicate with another computer that manages the database, depending on the embodiment.

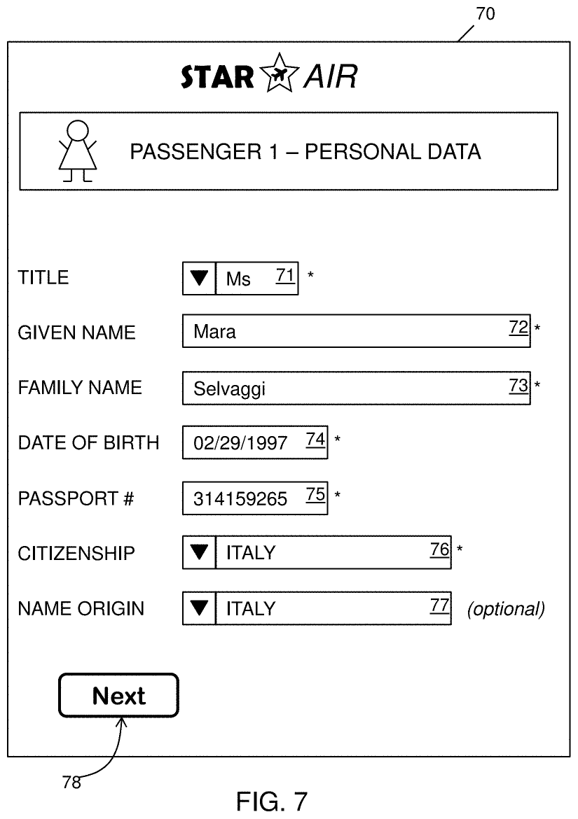

FIG. 7 shows an example of passenger enrollment through an airplane flight booking system in a web browser window 70. The system requests a selection of a title 71 that indicates gender or other personal status, a given name 72, a family name 73, date of birth 74, travel document number 75, a selection of a country of citizenship 76, and optionally a selection of a country of name origin 77. The browser window 70 further presents a Next button 78 for the person to move on to the next stage in selecting a flight ticket to purchase.

Gender and family name can be entered as lexical representations of the name and may indicate or inform one or more most likely name pronunciations. For example, the name Selvaggi, because it has a ‘gg’ and ends in ‘i’ is identifiable as a name that is likely to be Italian. If that hypothesis is correct, then the ‘gg’ is most likely pronounced as IPA characters dd [symbol] , the ‘a’ is most likely pronounced as IPA character a, and the ‘i’ is most likely pronounced as IPA character i. The selection of the country of citizenship 76 and name origin 77 are also both useful for hypothesizing the mapping of the lexical characters of the given and family name to phonetic characters. In this case, a pronunciation hint of a country name or a language name was generated from the lexical representation of a name.

### Phoneme Recognition

As described above, name pronunciation information stored in the database may be speech recordings in some embodiments. This has the benefit of algorithmic simplicity for both users, database owners, and systems that provide announcements or direct machine speech interfaces for their users. That being said, using a speech recording made by the individual mixed with synthesized speech may not sound natural and may even be difficult to understand due to the differences in pitch, cadence, tonal quality, and the like. It may not even sound as if the name is meant to be a part of the other speech if, for example, the recorded name is in a low-pitched male voice while the synthesized speech is using a high-pitched female voice.

However, it is also possible for a system to perform phoneme recognition to recognize one or more hypothesized sequences of phonemes that match the recording of the name pronunciation. In that case, it is possible to store just the recognized phoneme sequences. This uses less database storage space and also enables having a consistent voice for synthesized speech when mixed between message text and the personalized name pronunciation. Note that phoneme recognition is often a first step of speech recognition, but full speech recognition is not necessary to capture name pronunciation since name pronunciations are based on words that might or might not be in a known dictionary of recognizable words.

Some systems may take the lexical text of a person's name entry, look up a set of one or more possible pronunciations for the lexical text, and compare the recognized phonemes to the possible pronunciations of the lexical text before deciding whether to store the phoneme sequence of the pronunciation in the database. The possible pronunciations may be determined by looking up possible pronunciations from a dictionary of known pronunciations of names. It is possible to, also or instead, convert the lexical text, to one or more sequences of phonemes representing each permutation of possible pronunciations of the lexical characters. For languages with essentially one unique pronunciation of each character, such as Italian or Korean, the number of possible phoneme sequences will be few. For languages with many possible pronunciations for characters and multi-character combinations, such as English, French, or Spanish, there may be many possible phoneme sequences. For languages that have different pronunciations for the same characters, such as Mandarin, Cantonese, Shanghainese, and Japanese, there will generally be one possible pronunciation for each language. A pronunciation hint, such as the preferred language of the person may be used to help with the generation of the phoneme sequences.

If there is a match between the recognized phoneme sequences captured from a person's speech and a known possible pronunciation, then the matching phoneme sequence may be stored in the database. If there is no match, the system may simply store no phoneme sequence in the database or request that the person who spoke the name try again and capture a new speech recording. This may be referred to as an error indication. If a person tries a certain number of times, such as 3, without a successful match, then the system may move on without writing a phoneme sequence in the database or writing a default pronunciation mapped from the lexical name spelling. This avoids mistakes by people who do not, at first, understand how the system should work.

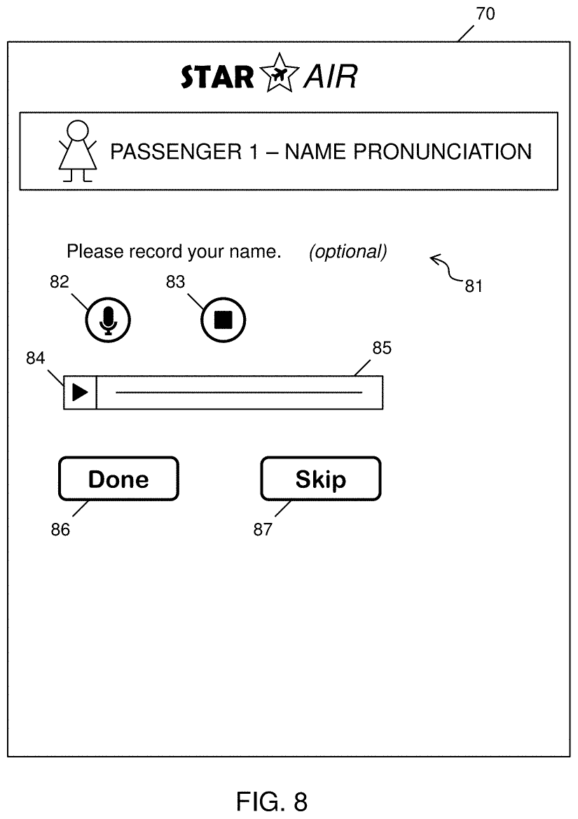

FIG. 8 shows an example of a web browser window 70, which may be shown on a client device being used by the person, for recording a person's spoken name. It shows the person a message 81 instructing them to record their name, but also informing them that the name recording is optional. The browser window 70 provides a microphone button 82 that causes the system to begin recording sound captured from a microphone connected to the client device that shows the browser window. After activating the microphone button 82, the person can activate the stop button 83 to stop recording. Activation may be by clicking using a pointer controlled by a mouse, tapping on a touch screen, or other means of selection. Some systems may make the stop button 83 invisible when not recording and the microphone button 82 invisible when recording is in progress. It is also possible for them to be in the same screen position if they are alternately visible.

The browser window 70 may also include a play button 84 and player progress line 85 in some embodiments. If a person activates the play button 84, the system may output the most recently recorded audio segment through speakers of the device displaying the web browser window. The player progress line 85 shows a cursor that moves left to right across the line while the audio plays. By being able to replay their recorded speech audio, the person can hear what they recorded to confirm whether it is acceptable or whether they would like to record their name pronunciation again differently.

When the person is satisfied with their recording, they may activate a Done button 86. If the person wishes to not record their name, such as because they are concerned about privacy or do not like the sound of their own voice, they may activate a Skip button 87 to move through the enrollment process without recording a name pronunciation by voice.

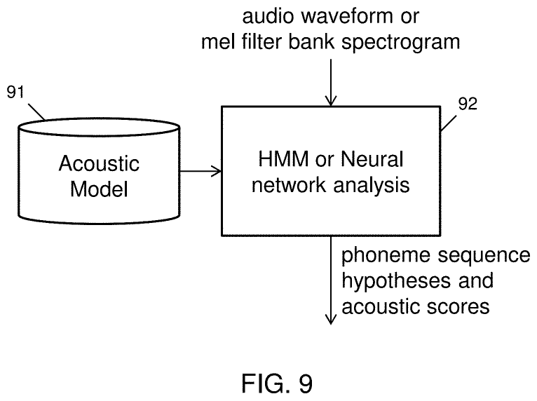

FIG. 9 shows how a phoneme sequence may be recognized from a recording of a name pronunciation. An acoustic model 91 is used. It is programmed or trained to compute, at time steps of the audio, statistical probabilities that each of a set of recognizable phonemes is being spoken. The acoustic model 91 may be a hidden Markov model (HMM) or neural network (NN). An appropriate neural network architecture may include recurrent nodes, such as a long short-term memory (LSTM) architecture.

A processor runs a software routine 92 that receives an audio waveform, processes it according to the model, and outputs a sequence of phonemes that may have been pronounced in the speech audio. It is possible to pre-process audio to convert it to frames and then perform a transform to a frequency domain representation such as energy levels on a mel filter bank scale. The phonemes may be computed one at a time and compiled into a sequence or a sequence may be computed at once within the software routine 92.

### Silly Names

A system may compare a recognized sequence of phonemes to known possible pronunciations of a corresponding lexical name. One type of comparison is to compute an edit distance. If the difference is too great, the system rejects the recording and may give the person an option of trying a new recording. Rejecting recordings or pronunciations that do not seem to match likely pronunciations of lexical text prevents pranksters from entering in the database funny or offensive phrases that would then be said over a PA system.

However, the above approach may prevent people from entering in the database honest preferred pronunciations of their name that differ too much from what the system is programmed to consider a match. To avoid this, a system may be designed to perform speech recognition on the recordings using a dictionary of specifically forbidden words containing cursing, sensitive, and offensive words. Assuming having the words “butt” and “face” in the list, when a person says my “name is butt face” the system recognizes the words as forbidden and returns the entry as invalid. The system could respond with a generic message (“Your name is invalid”) or with a more specific one (“I cannot accept your name because it contains unacceptable words”). The system may then use pronunciation information generated from the lexical representation of the person's name as its best attempt at generating the proper name pronunciation.

A system may also search within the recognized phoneme sequence for likely pronunciations and, if found, discard phonemes before and after. This can be done before computing an edit distance as part of a comparison of a hypothesized recognized phonemes and possible pronunciations of lexical names. This would pick out a name pronunciation even if a person spoke other words before and after. For example, if a person with lexical name Mara Selvaggi says, “I would like Mara Selvaggi to be the name you call me”, the system would search for all likely pronunciations of the lexical name Mara Selvaggi within the recognized phonemes, find that a phoneme sequence matching one likely pronunciation is present, and therefore discard the preceding words, “I would like” and the following words “to be the name you call me”. The system would proceed to store the phonemes for the pronunciation of Mara Selvaggi in the database.

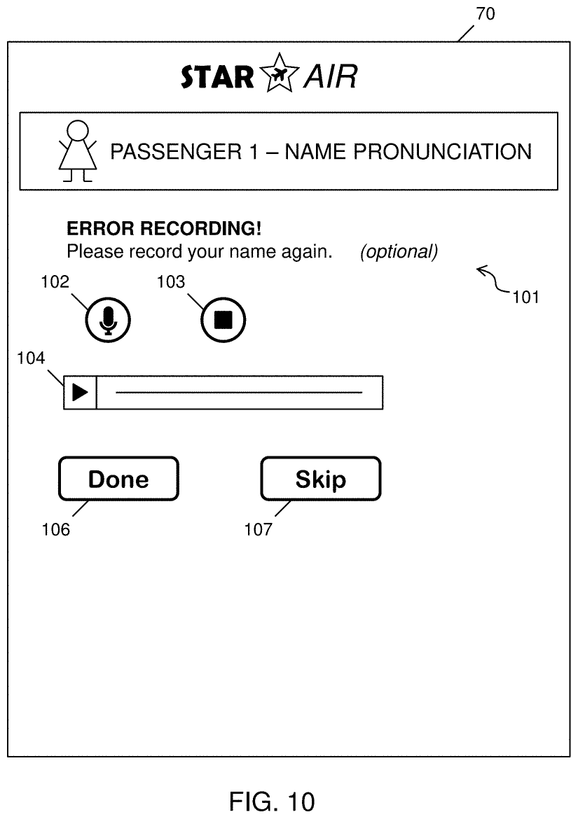

FIG. 10 shows a browser window 70 that provides a person an option to record their name again after an error. The browser window 70 gives a message 101 indicating that there was an error and asking the person to record the name again. The browser window also has a microphone button 102, a stop button 103, a play button 104, a Done button 106, and a Skip button 107 that operate like microphone button 82, stop button 83, play button 84, Done button 86, and skip button 87, respectively, as described above regarding FIG. 8.

### Mapping Pronunciations

Another approach that some systems may take is to only request a lexical name entry from people without requesting that they record speech of their name. Accordingly, the system may map the lexical text to a plurality of possible corresponding phoneme sequences and present the possible sequences to the person as a menu of pronunciations, each corresponding to one possible phoneme sequence. The system may then accept a choice from the person and store their chosen pronunciation as the preferred pronunciation in the database. This has the benefit of a simpler user interface in that they do not need to have a microphone available in their registration system, people not needing to know how to start and stop the recording of their name pronunciation, and systems not having to perform phoneme recognition, which is potentially inaccurate, and technically complex to implement.

To allow people to choose a preferred pronunciation from a menu, a system may show them a written description of the possible pronunciations. This may be done with a language-independent alphabet such as IPA or a language-specific set of sound representations. It is also possible to provide a mechanism, such as a button to click or menu option to activate to cause the system to synthesize speech audio corresponding to any of the possible pronunciations in the menu and output the speech audio to a loudspeaker for the person to hear before making their selection. This may provide the most accurate way for people to hear the way that their chosen preferred pronunciation will sound when pronounced through a PA system or direct user interface.

As described above, the menu of possible name pronunciations may be determined by a lookup in a dictionary of known pronunciations corresponding to lexical names or may, alternatively or additionally, be inferred according to a set of lexeme to phoneme rules. The system may provide any number of choices, depending on the embodiment, to trade off complexity and screen space against the likelihood of the person finding a pronunciation that is acceptably close to what they prefer.

It is also possible for a system to determine which possible pronunciations to present on the menu or sort the menu items in an order that depends on other information about the person. The pronunciations may be based on an inferred ethnicity, which may be determined from pronunciation hint information such as their country of residence, country of citizenship, an ethnic group, a religious preference, a gender, a language, or a specification of their name origin.

The approach of showing a menu of possible pronunciations for a person to select can also be combined with the approach of allowing the person to record their name. Sometimes a recorded name may be recognized as one or another hypothesized phoneme sequence. Showing a menu of most-likely hypotheses, a person may confirm which pronunciation they prefer.

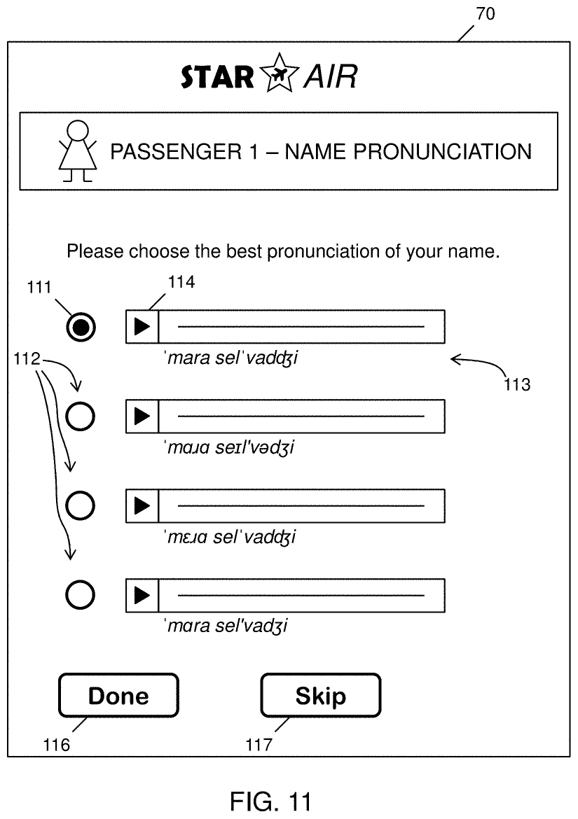

FIG. 11 shows a browser window 70 that provides a person a menu of possible pronunciations. It shows a selected radio button 111 and three unselected radio buttons 112. If the person selects any unselected button, it becomes selected, and all others become unselected so that only one may be selected at a time. For each pronunciation on the menu, the browser window 70 shows a pronunciation using IPA characters 113 and a play button 114 that a person can use to hear a synthesized voice speaking the corresponding pronunciation. The browser window has a Done button 116. When activated, the pronunciation corresponding to whichever radio button is selected is written to the database as the person's preferred name pronunciation. The browser window 70 also has a Skip button 117 that a person can use if they wish not to provide a preferred pronunciation, such as for wanting to maintain the privacy of an unusually pronounced name in PA announcements.

### System Architecture

Some systems are a single integrated computer system. However, other system architectures are possible. Some systems use a client-server architecture. This has the benefit of a server being available to maintain a common database of people's preferred name pronunciations that can be used by multiple clients, perhaps for different purposes. If a preferred name pronunciation is an entry of a user profile for users of systems such as Google, Apple, Amazon, or Facebook, many other companies, web sites, apps, and services that integrate with those companies may read the preferred name pronunciation in order to provide the best possible service to people. The ability to read personal information, such as a name pronunciation, may be controlled such that the user must authorize the system to provide access to the service provider.

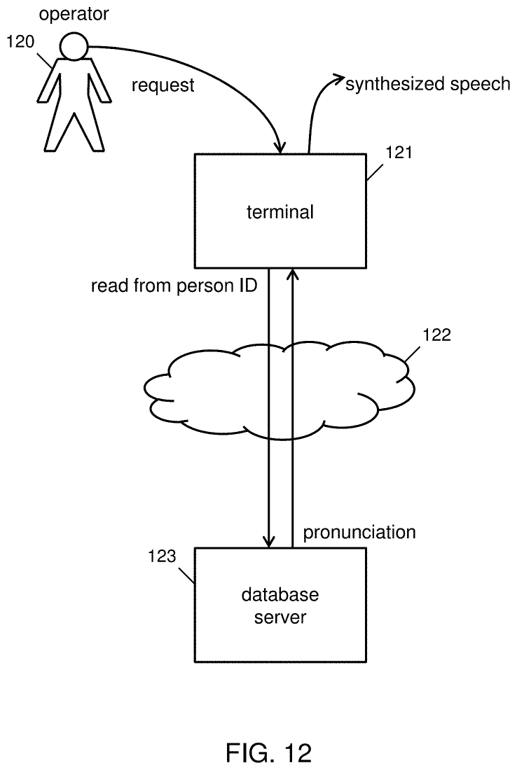

FIG. 12 shows, as an example, a PA system with a client-server architecture. An operator 120 uses an operator interface of a terminal to request an automated announcement for a specifically chosen person ID. The terminal 121 sends a read request over a network 122 using an application programming interface (API) call to a database server 123. The database server 123 responds, through the network, to the terminal 121 by sending a preferred name pronunciation. Terminal 121 then proceeds to synthesize speech of the announcement, including speech synthesized with the preferred name pronunciation and output the synthesized speech audio as an announcement. It is also possible, in some systems, for the server to perform the speech synthesis as a service for the terminal. This simplifies the design of the terminal and allows the server company to provide speech synthesis for many different types of terminals and other devices in one feature-rich system.

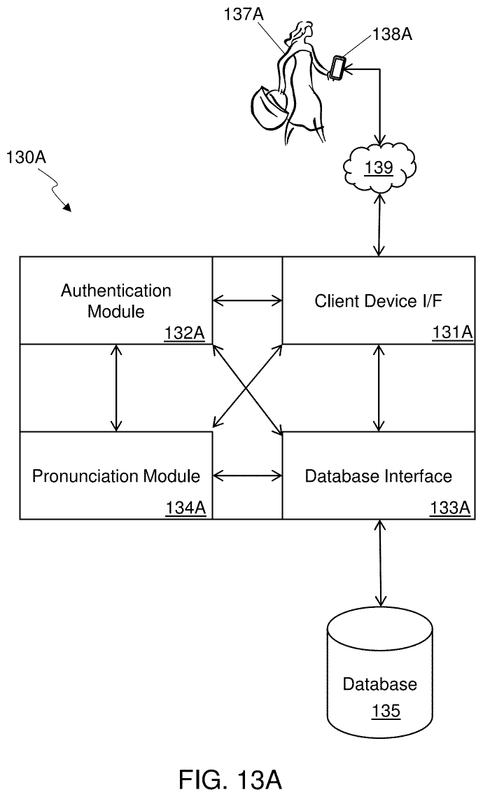

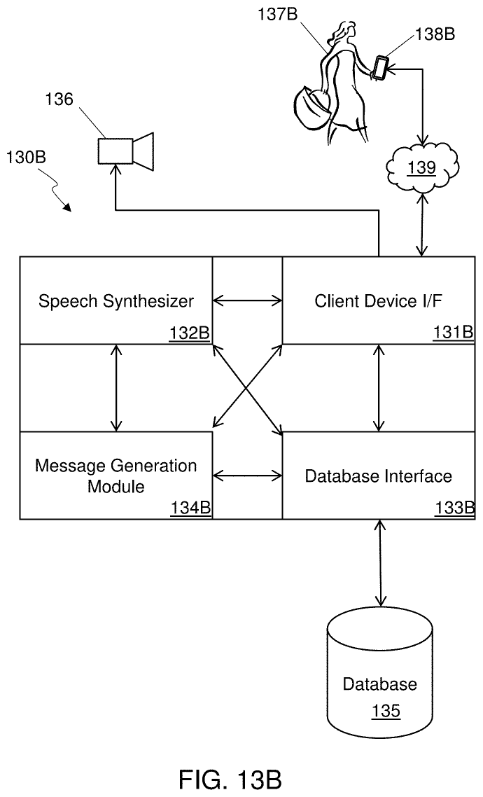

FIG. 13A shows a schematic diagram of a system 130A appropriate for some embodiments of a computerized system for personalizing a name pronunciation. The system 130A includes a client device interface 131A configured to communicate with a client device 138A used by a person 137A. The client device interface 131A may implement any type of communication interface, including, but not limited to, Ethernet, Universal Serial Bus (USB), any variation of Institute of Electrical and Electronic Engineers (IEEE) 802.11 (also known as WiFi), or 3G, 4G long-term evolution (LTE), 5G, and other wireless interface standard radios. The client device interface 131A may communicate with the client device 138A through the internet 139 or any type of networking infrastructure including routers, switches, and other servers. Any type and/or combination of networking protocols may be used for the communication between the client device interface 131A and the client device, including HTTP, transmission control protocol (TCP), and/or internet protocol (IP). In some embodiments the client device interface may include a web server to provide HTML web pages to the client device 138A.

The system 130A also includes an authentication module 132A configured to accept authentication information received from the client device 138A through the client device interface 131A and determine a person ID for the person 137A. In some embodiments, the authentication module 132A is configured to perform an authentication in compliance with the US Health Insurance Portability and Accountability Act (HIPAA) before determining the person ID for the person 137A. The authentication module 132A may communicate with an external authorization service running on another computer using an OAuth protocol or any other type of communication, or the authentication module 132A may utilize its own authentication database to determine whether the username/password tuple is valid and associated with an account on the system 130A. The authentication information received from the client device 138A may include a previously created username/password tuple that can be authenticated to associate the username with a previously created record in the person database and the person ID for the person is then a pre-existing person ID associated with the person in the database. The person ID may be returned by the authentication module 132A after the authentication. In some embodiments, the username, after it has been authenticated may be used as the person ID. If the authentication information includes a new username/password tuple for an account that has not been previously created, the authentication module 132A may be configured to generate a new person ID as the person ID for the person and may pass the person ID to the database interface 133A to have a new record created for the person in the database 135.

A database interface 133A configured to access a database 135 that stores a plurality of records about people is also a part of the system 130A. The records of the plurality of records include fields such as shown in FIG. 1, including fields for the person ID, a lexical representation of a name of the person, and pronunciation information for the name. Any type of database may be used including a relational database such as, but not limited to, Microsoft® SQL Server, Oracle® Database, or IBM® DB2, a NoSQL database such as, but not limited to, Apache Cassandra or mongoDB®, a cloud database such as, but not limited to, Microsoft Azure® SQL Database or Amazon® Relational Database Service, or even a spreadsheet such as, but not limited to Microsoft Excel® or Google® Sheets.

The system 130A also includes a pronunciation module 134A configured to receive an input from the person 137A through the client device interface 131A, create pronunciation information for the name of the person 137A, different than the lexical representation of the name, based on the input from the person 137A, and provide the pronunciation information to the database interface 133A for storage associated with the person ID in the database 135. The pronunciation module 134A may determine the pronunciation information internally without input from the person 137A, or may interact with the person 137A through the client device interface 131A to determine the pronunciation information. The pronunciation module 134A may determine the pronunciation information for the name of the person according to any of the methods described herein.

The system 130A may be implemented one or more server systems that each include one or more processors running code to perform methods described herein. In some embodiments, the client device interface 131A, authentication module 132A, the pronunciation module 134A, and the database interface 133A, as well as the database 135 may all be a part of a single server computer system. In other embodiments, one or more of the client device interface 131A, authentication module 132A, the pronunciation module 134A, the database interface 133A, and the database 135 may be implemented on a separate server system or even distributed among multiple server systems. The various server systems may communication using any type of networking or communication technology.

FIG. 13B shows a schematic diagram of a system 130B appropriate for some embodiments of a computerized system for delivering a message with personalized name pronunciation for a person associated with a person ID. The system 130B includes a client device interface 131B configured to communicate with a client device 138B used by a person 137B. The client device interface is also configured to communicate with a speaker 136 which may be a part of the client device 138B or may be separate from the client device 138B depending on the embodiment. The person 137B may or may not have previously set up personalized information for themselves and may or may not be the person for whom the message is targeted, depending on the embodiment. For example, if the system 130B is used as a public address system, the person 137B may be an operator of the public address system using a desktop computer as the client device 138B with the message targeted to another person and sent to the speaker 136 that may be audible to the target of the message, not a speaker of the client device 138B. But if the system 130B is used for an interactive voice response (IVR) system, the person 137B may be logged into an account associated with the IVR system and have previously set up personalized pronunciation information for their name in the IVR system. In the system 130B used for an IVR system the message maybe targeted to the person 137B and the speaker 136 may be a part of the client device 138B.

The client device interface 131B may implement any type of communication interface, including, but not limited to, Ethernet, Universal Serial Bus (USB), any variation of Institute of Electrical and Electronic Engineers (IEEE) 802.11 (also known as WiFi), or 3G, 4G long-term evolution (LTE), 5G, and other wireless interface standard radios. The client device interface 131B may communicate with the client device 138B through the internet 139 or any type of networking infrastructure including routers, switches, and other servers. Any type and/or combination of networking protocols may be used for the communication between the client device interface 131B and the client device 138B, including HTTP, transmission control protocol (TCP), and/or internet protocol (IP). In some embodiments the client device interface may include a web server to provide HTML, web pages to the client device 138B. The client device interface 131B may provide audio to the speaker 136 by any known method, including by communication with the client device 138B as described above. If the speaker 136 is separate from the client device 138B, the client device interface 131B may send audio information to the speaker 136 as analog or digital information and the speaker 136 may include an audio amplifier, a digital-to-analog converter, a network interface, or any other type of circuitry integrated with the speaker 136 or positioned between the speaker 136 and the client device interface 131B, depending on the embodiment.

The system 130B may also include an authentication module enabled to accept authentication information received from the client device 138B through the client device interface 131B and determine a person ID for the person 137B or to authorize the person 137B to initiate an announcement for another person associated with the person ID. The authentication module may function similarly to the authentication module 132A described above.

A database interface 133B configured to access the database 135 that stores a plurality of records about people is also a part of the system 130B. The records of the plurality of records include fields for the person ID, a lexical representation of a name of the person, and pronunciation information for the name such as shown in FIG. 1 and can retrieve a record from the database using the person ID. The database 135 may be shared with system 130A as described above in some embodiments and the pronunciation information may have been specified by the person associated with the person ID using the system 130A. Any type of database may be used including a relational database such as, but not limited to, Microsoft® SQL Server, Oracle® Database, or IBM® DB2, a NoSQL database such as, but not limited to, Apache Cassandra or mongoDB®, a cloud database such as, but not limited to, Microsoft Azure® SQL Database or Amazon® Relational Database Service, or even a spreadsheet such as, but not limited to Microsoft Excel® or Google® Sheets.

The system also includes a message generation module 134B configured to obtain at least a portion of a script and the person ID associated with the person for whom the message is personalized. The portion of the script includes a lexical text segment to be converted to speech and a name placeholder. The script may be obtained from another portion of the database 135 or from another database. The script and/or the person ID may be selected explicitly by the person 137B from a full or filtered list of possible scripts and/or person IDs. In other embodiments, the script and/or person ID may be automatically selected based on actions by person 137B, such as their interaction with previous user interface elements of the system 130B. The person ID may be obtained based on an account login provided by the authentication module in some embodiments.

A speech synthesizer 132B is included in the system 130B. The speech synthesizer 132B is configured to obtain pronunciation information for the name and the lexical representation of the name, different than the pronunciation information, from the database interface 133B in response to providing the person ID to the database interface 133B. The speech synthesizer 132 is also configured to synthesize speech representing the lexical text of the portion of the script and generate an audio name based on the pronunciation information. This may be done by synthesizing the audio name based on a phonetic text representation of the name retrieved as the pronunciation information. The phonetic text representation of the name may utilize the international phonetic alphabet or the CMU English phoneme codes and the phonetic text representation of the name may be encoded with a language-independent alphabet. In some embodiments, the pronunciation information includes a recording of a spoken name.

The system 130B may be implemented using one or more server systems that each include one or more processors running code to perform methods described herein. In some embodiments, the client device interface 131B, authentication module, the speech synthesizer 132B, the message generation module 134B, and the database interface 133B, as well as the database 135 may all be a part of a single server computer system. In other embodiments, one or more of the client device interface 131B, authentication module, the speech synthesizer 132B, the message generation module 134B, the database interface 133B, and the database 135 may be implemented on a separate server system or even distributed among multiple server systems. The various server systems may communicate using any type of networking or communication technology. In some embodiments a single server may be used to implement both the system 130A and the system 130B and may share functionality, such as the client device interface 131 and the database interface 133 between the two systems.

Aspects of various embodiments are described with reference to flowchart illustrations and/or block diagrams of methods, apparatus, systems, and computer program products according to various embodiments disclosed herein. It will be understood that various blocks of the flowchart illustrations and/or block diagrams, and combinations of blocks in the flowchart illustrations and/or block diagrams, can be implemented by computer program instructions or by configuration information for a field-programmable gate array (FPGA). These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. Similarly, the configuration information for the FPGA may be provided to the FPGA and configure the FPGA to produce a machine which creates means for implementing the functions/acts specified in the flowchart and/or block diagram block or blocks.

These computer program instructions or FPGA configuration information may be stored in a computer readable medium that can direct a computer, other programmable data processing apparatus, FPGA, or other devices to function in a particular manner, such that the data stored in the computer readable medium produce an article of manufacture including instructions which implement the function/act specified in the flowchart and/or block diagram block or blocks. The computer program instructions or FPGA configuration information may also be loaded onto a computer, FPGA, other programmable data processing apparatus, or other devices to cause a series of operational steps to be performed on the computer, FPGA, other programmable apparatus, or other devices to produce a computer implemented process for implementing the functions/acts specified in the flowchart and/or block diagram block or blocks.

The flowchart and/or block diagrams in the figures help to illustrate the architecture, functionality, and operation of possible implementations of systems, methods, and computer program products of various embodiments. In this regard, each block in the flowchart or block diagrams may represent a module, segment, or portion of code comprising one or more executable instructions, or a block of circuitry, for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

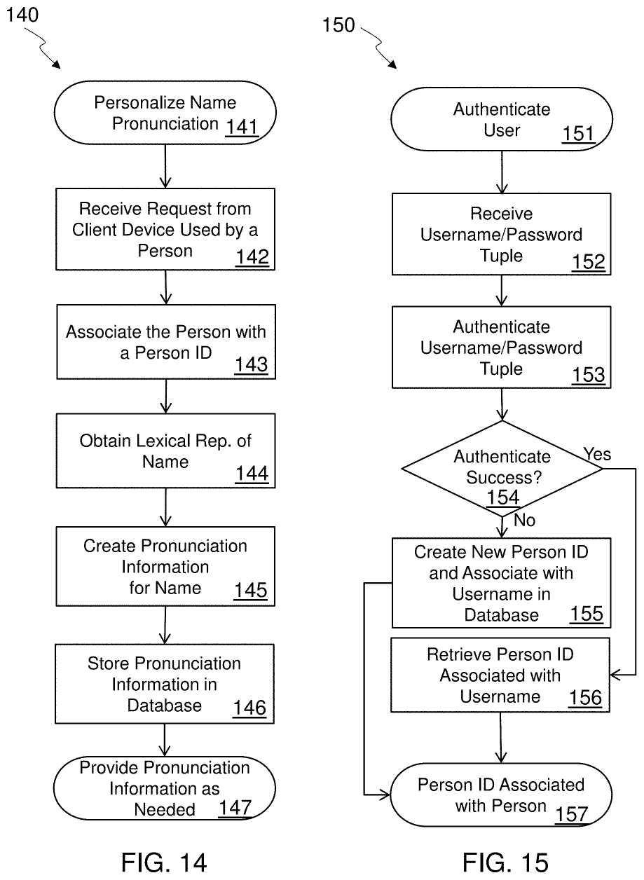

FIG. 14 is a flowchart 140 of an embodiment of a method for personalization of name pronunciation 141. The method includes receiving 142 a request from a client device used by a person and associating 143 the person with a person ID. The request may include a request for authentication as shown in FIG. 15 and/or may include a request to create or update a record for the person. The method continues with obtaining 144 a lexical representation of a name of the person. The lexical (e.g. textual) representation of the name may be obtained from the person by having them enter text into their client device, or may be obtained by reading the lexical representation from the database using the person ID.

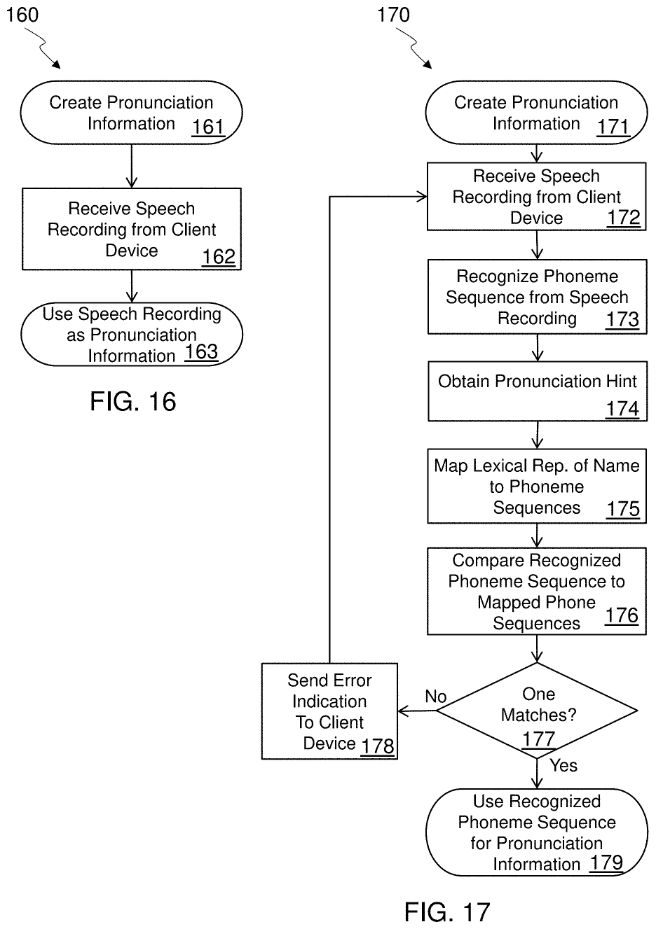

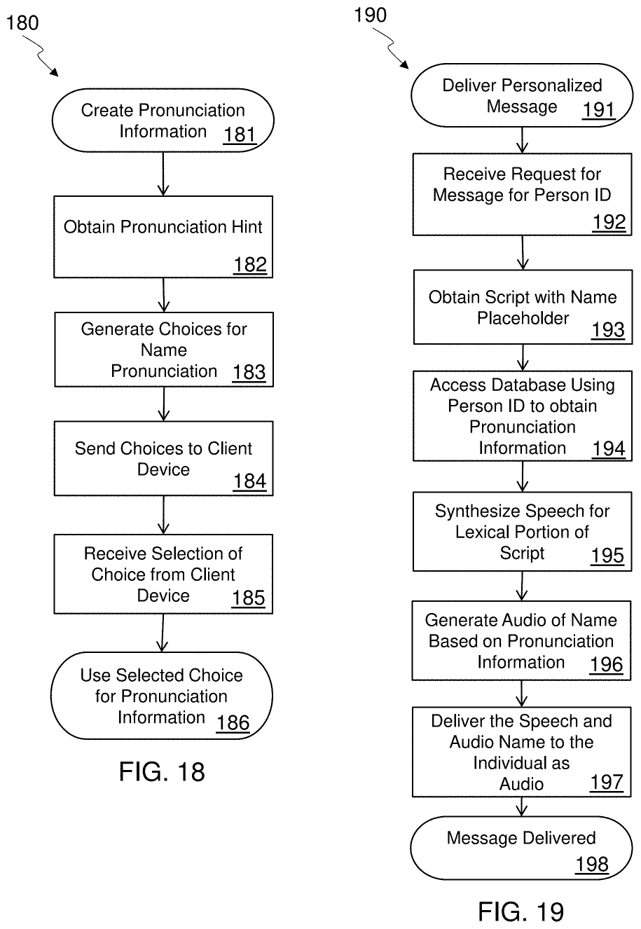

Pronunciation information for the name of the person, different than the lexical representation of the name, is created 145 based on an input from the person to the client device. Various embodiments of creating pronunciation information are described herein, including in FIG. 16, FIG. 17, and FIG. 18. The pronunciation information may include any type of computer data, including data representing audio, such as a spoken name, data representing phonetic text, such as the international phonetic alphabet or the CMU English phoneme codes. The phonetic text may be encoded with a language-independent alphabet stored as computer data. The pronunciation information is then stored 146 with the lexical representation of the name associated with the person ID in a database. The pronunciation information may then be provided 147 as needed to other applications such as public address systems, interactive voice systems, or customer service systems.

FIG. 15 is a flowchart 150 of an embodiment of a method for authenticating 151 a user in a system for name pronunciation. The method includes receiving 152 a username/password tuple from a client device used by a person. An attempt to authenticate 153 the username/password tuple is then made. This can be done using a local database of valid username/password tuples to associate them with an account or a person ID or by using an external authentication service, such as, but not limited to, an OAuth service. The success of the authentication is then evaluated 154. If the authentication did not succeed, a new account may be created for the username/password tuple. Thus the request may initiate creation 155 of a new record for the person in the database and generation of a new person ID. As a part of creating the new record, the lexical representation of the name of the person may be provided by the person using their client device. If the authentication is successful, the request may be for an update of a record for the person in the database, so the person ID associated with that username may be retrieved 156. In this case the lexical representation of the name of the person may be retrieved from the database 157. Also, an authentication in compliance with the US Health Insurance Portability and Accountability Act may be performed before receiving the request to update the record.

FIG. 16 is a flowchart 160 of an embodiment of a method for creating 161 pronunciation information. The method includes receiving 162 a speech recording from the client device. In such embodiments, the input from the person to the client device includes the speech recording. The speech recording may be done by the person using a microphone in or attached to their client device. The speech recording may then be used 163 as the pronunciation information and stored in the database as an audio file.

FIG. 17 is a flowchart 170 of an alternative embodiment of a method for creating 171 pronunciation information. The method includes receiving 172 a speech recording from the client device. In such embodiments, the input from the person to the client device includes the speech recording. The speech recording may be done by the person using a microphone in or attached to their client device. A phoneme sequence is recognized 173 from the speech recording. The recognizing of the speech recording may be done in any way, including methods described herein. In at least one embodiment, a pronunciation hint associated with the person is obtained 174, although other embodiments may not use a pronunciation hint. Any type of pronunciation hint may be used, including, but not limited to, a geographic identifier, an ethnic group, a religious preference, a gender, and/or a language associated with the person. The pronunciation hint may be provided by the person, retrieved from the database using the person ID, or obtained from some other source.

The method may also map 175 the lexical representation of the name to a plurality of phoneme sequences. If a pronunciation hint has been obtained, the pronunciation hint may be used with the lexical representation of the name to generate the plurality of phoneme sequences. The recognized phone sequence is then compared 176 to the plurality of generated phoneme sequences to determine 177 whether the recognized phoneme sequence from the speech recording matches one of the plurality of phoneme sequences generated from the lexical representation of the name. If no match between the recognized phoneme sequence and one of the plurality of phone sequences is found an error indication is sent 178 to the client device. The error indication may then initiate another attempt to create 172 pronunciation information by receiving a new speech recording from the client device, although some embodiments may take other action. If the recognized phoneme sequence matches one of the plurality of generated phoneme sequences, the recognized phoneme sequence is used 179 to create the pronunciation information. The phoneme sequence itself may be saved in the database or some other representation of the phoneme sequence, such as a synthesized audio clip of the phoneme sequence or a translation of the phoneme sequence into a language independent alphabet, may be saved as the pronunciation information.

In at least one embodiment, creating pronunciation information may include mapping 175 the lexical representation of the name to a plurality of phoneme sequence and determining whether the recognized phoneme sequence matches one of the plurality of phoneme sequences 175, 176. If it is determined that the recognized phoneme sequence does not match one of the plurality of phoneme sequences, speech recognition is performed on the speech recording to determine one or more words spoken and the one or more words spoken are compared to a list of forbidden words. If it is determined that the one or more words spoken does not include any words in the list of forbidden words, the recognized phoneme sequence may be used as the pronunciation information. If, however, it is determined that the one or more words spoken include at least one word in the list of forbidden words, one of the plurality of phoneme sequences is used to create the pronunciation.

FIG. 18 is a flowchart 180 of another alternative embodiment of a method for creating 181 pronunciation information. The method optionally includes obtaining 182 a pronunciation hint. Any type of pronunciation hint may be used, including, but not limited to, a geographic identifier, an ethnic group, a religious preference, a gender, and/or a language associated with the person. The pronunciation hint may be provided by the person, retrieved from the database using the person ID, or obtained from some other source. A plurality of choices for pronunciation of the name is generated 183 based on the lexical representation of the name and the pronunciation hint, if used by the embodiment. This may be done by any known method, but in some embodiments, the generation of the plurality of choices for pronunciation of the name is done by mapping the lexical representation of the name to a plurality of phoneme sequences using the plurality of phoneme sequences to generate the plurality of choices for the pronunciation of the name. In various embodiments, the mapping may include a dictionary lookup and/or the use of lexeme to phoneme rules.

The plurality of choices for pronunciation of the name are sent 184 to the client device for presentation to the person. The plurality of choices for the pronunciation of the name sent to the client may include phonetic text and or sound data. Sound data may include an audio file, streaming audio sent over the internet, an audio clip, or any other computer-accessible data representing sound. The choices are presented to the person by the client device and the selection of the person is then sent back as the input from the person to the client device. The method then also includes receiving 185 a selection of one of the plurality of choices for the pronunciation of the name from the client device. The pronunciation information is then created 186 from the selected one of the plurality of choices for the pronunciation of the name.

FIG. 19 is a flowchart 190 of an embodiment of a method for delivering 191 a message with personalized name pronunciation. The method includes receiving 192 a message request to provide a message that includes the name of the person associated with a person ID. The person ID may be obtained by any method, but it may be provided with the request in some embodiments, such as in a public address system. In other embodiments, the person ID may be associated with an account being used for the generation of a message, such as in an interactive voice response system.

At least a portion of a script is obtained 193 as the method continues. The portion of the script includes a lexical text segment to be converted to speech and a name placeholder. The name placeholder can be represented as a tag in the lexical text of the script, such as by surrounding the word “NAME” with angle brackets or any other type of tag, depending on the embodiment. A database may be accessed 194 using the person ID to obtain the pronunciation information for the name of a person associated with the person ID. Speech representing the lexical text of the portion of the script is synthesized 195 and an audio representation of the name is generated 196 based on the pronunciation information. In some embodiments the pronunciation information includes a recording of the spoken name so the audio representation of the name may be a copy of the recording of the spoken name. In other embodiments, the pronunciation information includes a phonetic text representation of the name or a synthesized audio clip synthesized from the phonetic text representation of the name, so the audio representation of the name includes synthesized speech generated using the phonetic text representation of the name.

The audio representation of the name may then be inserted into the stream of the synthesized speech representing the lexical text of the script at the appropriate place based on the placement of the name placeholder in the script and the synthesized speech and the audio representation of the name are delivered 197 to at least one individual as audio. Thus, the message with personalized pronunciation of a name is delivered 198.

As will be appreciated by those of ordinary skill in the art, aspects of the various embodiments may be embodied as a system, device, method, or computer program product apparatus. Accordingly, elements of the present disclosure may take the form of an entirely hardware embodiment, an entirely software embodiment (including firmware, resident software, micro-code, or the like) or an embodiment combining software and hardware aspects that may all generally be referred to herein as a “apparatus,” “server,” “circuitry,” “module,” “client,” “computer,” “logic,” “FPGA,” “system,” or other terms. Furthermore, aspects of the various embodiments may take the form of a computer program product embodied in one or more computer-readable medium(s) having computer program code stored thereon. The phrases “computer program code” and “instructions” both explicitly include configuration information for an FPGA or other programmable logic as well as traditional binary computer instructions, and the term “processor” explicitly includes logic in an FPGA or other programmable logic configured by the configuration information in addition to a traditional processing core. Furthermore, “executed” instructions explicitly includes electronic circuitry of an FPGA or other programmable logic performing the functions for which they are configured by configuration information loaded from a storage medium as well as serial or parallel execution of instructions by a traditional processing core.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random access memory, the data storage in a computer-readable storage medium can be considered to be non-transitory.

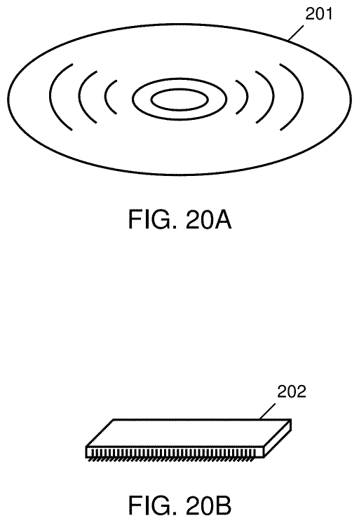

FIG. 20A shows an example non-transitory computer readable medium 201 that is a rotating magnetic disk. Data centers with databases that store name pronunciations may use magnetic disks to store data and code comprising instructions for server processors. Non-transitory computer readable medium 201 stores code comprising instructions that, if executed by one or more computers, would cause the computer to perform steps of methods described herein. Rotating optical disks and other mechanically moving storage media are possible.

FIG. 20B shows another example non-transitory computer readable medium 202 that is a Flash random access memory (RAM) chip. Data centers may use Flash memory to store data and code for server processors. Client devices may use Flash memory to store data and code for processors within system-on-chip devices. Non-transitory computer readable medium 202 stores code comprising instructions that, if executed by one or more computers, would cause the computer to perform steps of methods described herein. Other non-moving storage media packaged with leads or solder balls are possible.

Computer program code for carrying out operations for aspects of various embodiments may be written in any combination of one or more programming languages, including object oriented programming languages such as Java, Python, C++, or the like, conventional procedural programming languages, such as the “C” programming language or similar programming languages, or low-level computer languages, such as assembly language or microcode. In addition, the computer program code may be written in Verilog or another hardware description language to generate configuration instructions for an FPGA or other programmable logic. The computer program code if converted into an executable form and loaded onto a computer, FPGA, or other programmable apparatus, produces a computer implemented method. The instructions which execute on the computer, FPGA, or other programmable apparatus may provide the mechanism for implementing some or all of the functions/acts specified in the flowchart and/or block diagram block or blocks. In accordance with various implementations, the computer program code may execute entirely on the user's device, partly on the user's device and partly on a remote device, or entirely on the remote device, such as a cloud-based server. In the latter scenario, the remote device may be connected to the user's device through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So a processor programmed to perform a task is transformed from what the processor was before being programmed to perform that task, much like a physical plumbing system with different valves can be controlled to change the physical flow of a fluid.

Some computer systems are stationary, such as a vending machine, a desktop computer, or a server. Some systems are mobile, such as a laptop or an automobile. Some systems are portable, such as a mobile phone. Some systems comprise manual human interfaces such as keyboards or touchscreens and some systems include microphones and/or speakers to enable audio interaction.

One kind of computerized system uses a system-on-chip (SoC). SoCs are semiconductor devices that include the functionality of one or more computer processors and the functionality of peripheral devices. Each functionality may be represented as semiconductor intellectual property (IP) cores.

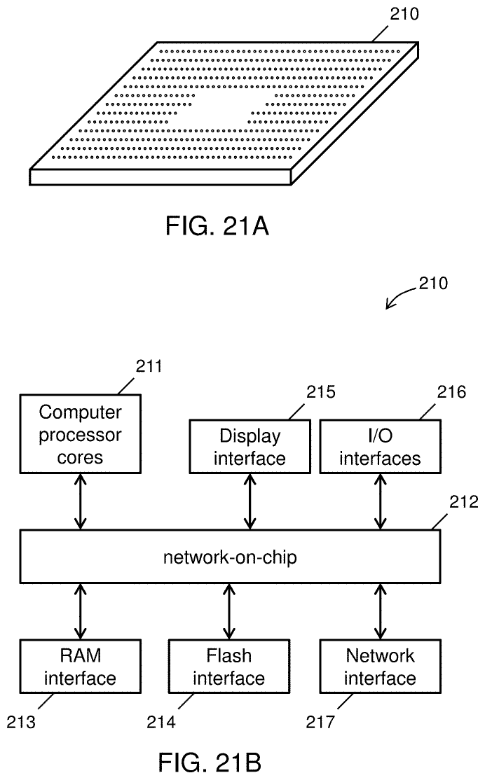

FIG. 21A shows the bottom side of a packaged system-on-chip device 210 with a ball grid array for surface-mount soldering to a printed circuit board. Various package shapes and sizes are possible for various chip implementations. SoC devices control many embedded systems and IoT devices such as stationary and mobile terminals for public address systems or self-service voice interfaces.

FIG. 21B shows a block diagram of the SoC 210. It may include a multicore cluster of computer processor (CPU) cores 211. The processors may connect through a network-on-chip 212 to an off-chip dynamic random access memory (DRAM) through RAM interface 213 for volatile program and data storage and/or through Flash interface 214 to access non-volatile storage of computer program code in a Flash RAM non-transitory computer readable medium. SoC 210 also has a display interface 215 for displaying a GUI and an I/O interface module 216 for connecting to various I/O interface devices such as microphones, speakers, amplifiers, keyboards, and other input and output interfaces. SoC 210 also comprises a network interface 217 to allow the processors to access the Internet through wired or wireless connections such as WiFi, 3G, 4G long-term evolution (LTE), 5G, and other wireless interface standard radios as well as Ethernet connection hardware. By executing instructions stored in RAM devices through interface 213 or Flash devices through interface 214, the CPUs 211 may perform steps of methods as described herein.

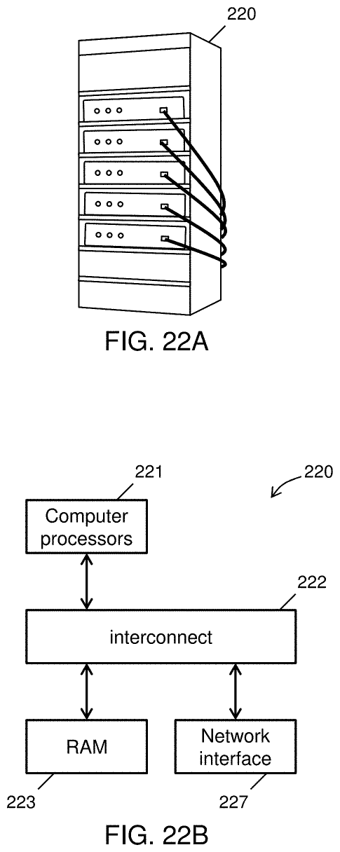

FIG. 22A shows a rack-mounted server blade multi-processor server system 220, which holds a person information database and responds to read requests with name pronunciations and other information about people represented in the database. The server comprises a multiplicity of network-connected computer processors that run software in parallel.

FIG. 22B shows a block diagram of the server system 220. It comprises a multicore cluster of computer processor (CPU) cores 221. The processors connect through a board-level interconnect 222 to random-access memory (RAM) devices 223 for program code and data storage. Server system 220 also comprises a network interface 227 to allow the processors to access the Internet. By executing instructions stored in RAM devices 223, the CPUs 221 perform steps of methods as described herein.

Embodiments 1-73 Below Relate to Personalizing a Name Pronunciation.

Embodiment 1. A computerized method for personalizing a name pronunciation, the method comprising: receiving a request from a client device used by a person; associating the person with a person ID; obtaining a lexical representation of a name of the person; creating pronunciation information for the name of the person, different than the lexical representation of the name, based on an input from the person to the client device; and storing the pronunciation information with the lexical representation of the name associated with the person ID in a database.

Embodiment 2. The method of embodiment 1, wherein the request initiates creation of a new record for the person in the database, a new person ID is generated as the person ID in response to the request, and the lexical representation of the name of the person is provided by the person.

Embodiment 3. The method of embodiment 1, wherein the request initiates an update of a record for the person in the database, and the person ID and the lexical representation of the name of the person are retrieved from the database.

Embodiment 4. The method of embodiment 1, wherein the pronunciation information comprises phonetic text.

Embodiment 5. The method of embodiment 4, wherein the phonetic text utilizes the international phonetic alphabet or the CMU English phoneme codes.

Embodiment 6. The method of embodiment 4, wherein the phonetic text is encoded with a language-independent alphabet.

Embodiment 7. The method of embodiment 1, further comprising: receiving a speech recording from the client device, wherein the input from the person to the client device comprises the speech recording; and using the speech recording as the pronunciation information.

Embodiment 8. The method of embodiment 1, further comprising: receiving a speech recording from the client device, wherein the input from the person to the client device comprises the speech recording; recognizing a phoneme sequence from the speech recording; and using the recognized phoneme sequence to create the pronunciation information.

Embodiment 9. The method of embodiment 8, further comprising: mapping the lexical representation of the name to a plurality of phoneme sequences; and determining whether the recognized phoneme sequence matches one of the plurality of phoneme sequences; and sending an error indication to the client device in response to determining that the recognized phoneme sequence does not match one of the plurality of phoneme sequences.

Embodiment 10. The method of embodiment 8, further comprising: mapping the lexical representation of the name to a plurality of phoneme sequences; and determining whether the recognized phoneme sequence matches one of the plurality of phoneme sequences; and performing speech recognition on the speech recording to determine one or more words spoken in response to determining that the recognized phoneme sequence does not match one of the plurality of phoneme sequences; comparing the one or more words spoken to a list of forbidden words; using the recognized phoneme sequence as the pronunciation information in response to determining that the one or more words spoken does not include any words in the list of forbidden words.

Embodiment 11. The method of embodiment 8, further comprising: mapping the lexical representation of the name to a plurality of phoneme sequences; and determining whether the recognized phoneme sequence matches one of the plurality of phoneme sequences; and performing speech recognition on the speech recording to determine one or more words spoken in response to determining that the recognized phoneme sequence does not match one of the plurality of phoneme sequences; comparing the one or more words spoken to a list of forbidden words; using one of the plurality of phoneme sequences to create the pronunciation information in response to determining that the one or more words spoken include at least one word in the list of forbidden words.

Embodiment 11A. The method of embodiment 8, further comprising: mapping the lexical representation of the name to a phoneme sequence; comparing the phoneme sequence to a list of forbidden phoneme sequences; and using the phoneme sequence as the pronunciation information in response to determining that the phoneme sequence does not include any words in the list of forbidden words.

Embodiment 12. The method of embodiment 8, further comprising: synthesizing speech using the recognized phoneme sequence to create a synthesized audio clip; and storing the synthesized audio clip as the pronunciation information.

Embodiment 13. The method of embodiment 1, further comprising: generating a plurality of choices for pronunciation of the name based on the lexical representation of the name; sending the plurality of choices for pronunciation of the name to the client device for presentation to the person; receiving a selection of one of the plurality of choices for the pronunciation of the name from the client device, wherein the received selection represents the input from the person to the client device; and creating the pronunciation information from the selected one of the plurality of choices for the pronunciation of the name.

Embodiment 14. The method of embodiment 13, wherein at least one of the plurality of choices for the pronunciation of the name comprises phonetic text.

Embodiment 15. The method of embodiment 13, wherein at least one of the plurality of choices for the pronunciation of the name comprises sound data, such as a sound file or streaming audio.

Embodiment 16. The method of embodiment 13, the method further comprising: mapping the lexical representation of the name to a plurality of phoneme sequences; and using the plurality of phoneme sequences to generate the plurality of choices for the pronunciation of the name.

Embodiment 17. The method of embodiment 16, wherein the mapping includes a dictionary lookup.

Embodiment 18. The method of embodiment 16, wherein the mapping uses lexeme to phoneme rules.

Embodiment 19. The method of embodiment 13, further comprising: obtaining a pronunciation hint associated with the person; and using the pronunciation hint with the lexical representation of the name to generate the plurality of choices for the pronunciation of the name; wherein the pronunciation hint is selected from a group consisting of a geographic identifier, an ethnic group, a religious preference, a gender, and a language.

Embodiment 20. The method of embodiment 19, wherein the pronunciation hint is retrieved from the database using the person ID.

Embodiment 21. The method of embodiment 19, wherein the pronunciation hint is provided by the person.

Embodiment 22. The method of embodiment 1, further comprising performing an authentication in compliance with the US Health Insurance Portability and Accountability Act before receiving the request.

Embodiment 23. The method of embodiment 1, further comprising: receiving a message request to provide a message that includes the name of the person associated with the person ID; obtaining at least a portion of a script, the portion of the script comprising a lexical text segment to be converted to speech and a name placeholder; accessing the database using the person ID to obtain the pronunciation information for the name; synthesizing speech representing the lexical text of the portion of the script; generating an audio representation of the name based on the pronunciation information; and delivering the speech and the audio representation of the name to at least one individual as audio.

Embodiment 24. A computerized system for personalizing a name pronunciation, the system comprising: a client device interface configured to communicate with a client device used by a person; an authentication module configured to accept authentication information received from the client device through the client device interface and determine a person ID for the person; a database interface configured to access a database that stores a plurality of records, a record of the plurality of records including fields for the person ID, a lexical representation of a name of the person, and pronunciation information for the name; and a pronunciation module configured to receive an input from the person through the client device interface and create pronunciation information for the name of the person, different than the lexical representation of the name, based on the input from the person, and provide the pronunciation information to the database interface for storage associated with the person ID in the database.

Embodiment 25. The system of embodiment 24, wherein the authentication module is configured to perform an authentication in compliance with the US Health Insurance Portability and Accountability Act before determining the person ID for the person.

Embodiment 26. The system of embodiment 24, wherein the authentication information includes previously created username/password tuple, and the person ID for the person is a pre-existing person ID associated with the person in the database.

Embodiment 27. The system of embodiment 24, wherein the authentication information includes a new username/password tuple, and the authentication module is configured to generate a new person ID as the person ID for the person.

Embodiment 28. The system of embodiment 24, wherein the pronunciation information comprises phonetic text.

Embodiment 29. The system of embodiment 24, wherein the pronunciation module is further configured to: receive a speech recording as the input from the person; and use the speech recording as the pronunciation information.

Embodiment 30. The system of embodiment 24, wherein the pronunciation module is further configured to: receive a speech recording as the input from the person; and recognize a phoneme sequence from the speech recording; and use the recognized phoneme sequence to create the pronunciation information.

Embodiment 31. The system of embodiment 30, wherein the pronunciation module is further configured to: map the lexical representation of the name to a plurality of phoneme sequences; and determine whether the recognized phoneme sequence matches one of the plurality of phoneme sequences; and send an error indication through the client device interface in response to determining that the recognized phoneme sequence does not match one of the plurality of phoneme sequences.

Embodiment 32. The system of embodiment 30, wherein the pronunciation module is further configured to: map the lexical representation of the name to a plurality of phoneme sequences; and determine whether the recognized phoneme sequence matches one of the plurality of phoneme sequences; and perform speech recognition on the speech recording to determine one or more words spoken in response to determining that the recognized phoneme sequence does not match one of the plurality of phoneme sequences; compare the one or more words spoken to a list of forbidden words; use the recognized phoneme sequence as the pronunciation information in response to determining that the one or more words spoken does not include any words in the list of forbidden words.

Embodiment 33. The system of embodiment 30, wherein the pronunciation module is further configured to: map the lexical representation of the name to a plurality of phoneme sequences; and determine whether the recognized phoneme sequence matches one of the plurality of phoneme sequences; and perform speech recognition on the speech recording to determine one or more words spoken in response to determining that the recognized phoneme sequence does not match one of the plurality of phoneme sequences; compare the one or more words spoken to a list of forbidden words; use one of the plurality of phoneme sequences to create the pronunciation information in response to determining that the one or more words spoken include at least one word in the list of forbidden words.

Embodiment 34. The system of embodiment 30, wherein the pronunciation module is further configured to: synthesize speech using the recognized phoneme sequence to create a synthesized audio clip; and provide the synthesized audio clip as the pronunciation information to the database interface for storage.

Embodiment 35. The system of embodiment 24, wherein the pronunciation module is further configured to: generate a plurality of choices for pronunciation of the name based on the lexical representation of the name; send the plurality of choices for pronunciation of the name through the client device interface for presentation to the person on the client device; receive a selection of one of the plurality of choices for the pronunciation of the name as the input from the person; and create the pronunciation information from the selected one of the plurality of choices for the pronunciation of the name.

Embodiment 36. The system of embodiment 35, wherein at least one of the plurality of choices for the pronunciation of the name comprises phonetic text.

Embodiment 37. The system of embodiment 35, wherein at least one of the plurality of choices for the pronunciation of the name comprises a sound file.

Embodiment 38. The system of embodiment 35, wherein the pronunciation module is further configured to: obtain a pronunciation hint associated with the person; and use the pronunciation hint with the lexical representation of the name generate a plurality of phoneme sequences as the plurality of choices for the pronunciation of the name; wherein the pronunciation hint is selected from a group consisting of a country name, an ethnic group, a religious preference, a gender, and a language.

Embodiment 39. A non-transitory computer-readable storage medium storing instructions which, when executed by at least one processor, program the at least one processor to perform a method comprising: receiving a request from a client device used by a person; associating the person with a person ID; obtaining a lexical representation of a name of the person; creating pronunciation information for the name of the person, different than the lexical representation of the name, based on an input from the person to the client device; and storing the pronunciation information with the lexical representation of the name associated with the person ID in a database.

Embodiment 40. The storage medium of embodiment 39, wherein the request initiates creation of a new record for the person in the database, a new person ID is generated as the person ID in response to the request, and the lexical representation of the name of the person is provided by the person.

Embodiment 41. The storage medium of embodiment 39, wherein the request initiates an update of a record for the person in the database, and the person ID and the lexical representation of the name of the person are retrieved from the database.

Embodiment 42. The storage medium of embodiment 39, wherein the pronunciation information comprises phonetic text.

Embodiment 43. The storage medium of embodiment 42, wherein the phonetic text utilizes the international phonetic alphabet or the CMU English phoneme codes.

Embodiment 44. The storage medium of embodiment 42, wherein the phonetic text is encoded with a language-independent alphabet.

Embodiment 45. The storage medium of embodiment 39, the method further comprising: receiving a speech recording from the client device, wherein the input from the person to the client device comprises the speech recording; and using the speech recording as the pronunciation information.

Embodiment 46. The storage medium of embodiment 39, the method further comprising: receiving a speech recording from the client device, wherein the input from the person to the client device comprises the speech recording; recognizing a phoneme sequence from the speech recording; and using the recognized phoneme sequence to create the pronunciation information.

Embodiment 47. The storage medium of embodiment 46, the method further comprising: mapping the lexical representation of the name to a plurality of phoneme sequences; and determining whether the recognized phoneme sequence matches one of the plurality of phoneme sequences; and sending an error indication to the client device in response to determining that the recognized phoneme sequence does not match one of the plurality of phoneme sequences.

Embodiment 48. The storage medium of embodiment 46, the method further comprising: mapping the lexical representation of the name to a plurality of phoneme sequences; and determining whether the recognized phoneme sequence matches one of the plurality of phoneme sequences; and performing speech recognition on the speech recording to determine one or more words spoken in response to determining that the recognized phoneme sequence does not match one of the plurality of phoneme sequences; comparing the one or more words spoken to a list of forbidden words; using the recognized phoneme sequence as the pronunciation information in response to determining that the one or more words spoken does not include any words in the list of forbidden words.

Embodiment 49. The storage medium of embodiment 46, the method further comprising: mapping the lexical representation of the name to a plurality of phoneme sequences; and determining whether the recognized phoneme sequence matches one of the plurality of phoneme sequences; and performing speech recognition on the speech recording to determine one or more words spoken in response to determining that the recognized phoneme sequence does not match one of the plurality of phoneme sequences; comparing the one or more words spoken to a list of forbidden words; using one of the plurality of phoneme sequences to create the pronunciation information in response to determining that the one or more words spoken include at least one word in the list of forbidden words.

Embodiment 50. The storage medium of embodiment 46, the method further comprising: synthesizing speech using the recognized phoneme sequence to create a synthesized audio clip; and storing the synthesized audio clip as the pronunciation information.

Embodiment 51. The storage medium of embodiment 39, the method further comprising: generating a plurality of choices for pronunciation of the name based on the lexical representation of the name; sending the plurality of choices for pronunciation of the name to the client device for presentation to the person; receiving a selection of one of the plurality of choices for the pronunciation of the name from the client device, wherein the received selection represents the input from the person to the client device; and creating the pronunciation information from the selected one of the plurality of choices for the pronunciation of the name.

Embodiment 52. The storage medium of embodiment 51, wherein at least one of the plurality of choices for the pronunciation of the name comprises phonetic text.

Embodiment 53. The storage medium of embodiment 51, wherein at least one of the plurality of choices for the pronunciation of the name comprises a sound file.

Embodiment 54. The storage medium of embodiment 39, the method further comprising: mapping the lexical representation of the name to a plurality of phoneme sequences; and using the plurality of phoneme sequences to generate the plurality of choices for the pronunciation of the name.

Embodiment 55. The storage medium of embodiment 54, wherein the mapping includes a dictionary lookup.

Embodiment 56. The storage medium of embodiment 54, wherein the mapping uses lexeme to phoneme rules.

Embodiment 57. The storage medium of embodiment 39, the method further comprising: obtaining a pronunciation hint associated with the person; and using the pronunciation hint with the lexical representation of the name to generate the plurality of choices for the pronunciation of the name; wherein the pronunciation hint is selected from a group consisting of a country name, an ethnic group, a religious preference, a gender, and a language.

Embodiment 58. The storage medium of embodiment 57, wherein the pronunciation hint is retrieved from the database using the person ID.

Embodiment 59. The storage medium of embodiment 57, wherein the pronunciation hint is provided by the person.

Embodiment 60. The storage medium of embodiment 39, the method further comprising performing an authentication in compliance with the US Health Insurance Portability and Accountability Act before receiving the request.

Embodiment 61. The storage medium of embodiment 39, the method further comprising: receiving a message request to provide a message that includes the name of the person associated with the person ID; obtaining at least a portion of a script, the portion of the script comprising a lexical text segment to be converted to speech and a name placeholder; accessing the database using the person ID to obtain the pronunciation information for the name; synthesizing speech representing the lexical text of the portion of the script; generating an audio representation of the name based on the pronunciation information; and delivering the speech and the audio representation of the name to at least one individual as audio.

Embodiment 62. A computerized method of enrolling a person in a database, the method comprising: receiving, from the person, a lexical text entry of their name; receiving, from the person, a pronunciation of their name; and storing, in a database, the lexical text entry and the pronunciation keyed to a person ID.

Embodiment 63. The method of embodiment 62, wherein the pronunciation is a speech recording.

Embodiment 64. The method of embodiment 62, further comprising: recording speech audio; and recognizing a phoneme sequence from a speech recording of the pronunciation, wherein the stored pronunciation is the phoneme sequence.

Embodiment 65. The method of embodiment 64, further comprising: mapping the lexical text to a plurality of possible corresponding phonetic representations; comparing the phoneme sequence to the plurality of possible corresponding phonetic representations; and indicating an error to the person if the phoneme sequence does not match a possible corresponding phonetic representation.

Embodiment 66. The method of embodiment 65, wherein the mapping includes a dictionary lookup.

Embodiment 67. The method of embodiment 65, wherein the mapping uses lexeme to phoneme rules.

Embodiment 68. The method of embodiment 62, further comprising: mapping the lexical text to a plurality of possible corresponding phoneme sequences; presenting to the person a menu of pronunciations, each of the pronunciations corresponding to one of the phoneme sequences; and accepting a choice from the person, wherein the stored pronunciation is the phoneme sequence chosen by the person.

Embodiment 69. The method of embodiment 68, wherein the menu of pronunciations shows them as phonetic text.

Embodiment 70. The method of embodiment 68, further comprising: creating audio corresponding to the pronunciation; and outputting the audio to a loudspeaker for the person in response to a request from the person.

Embodiment 71. The method of embodiment 68, wherein the mapping includes a dictionary lookup.

Embodiment 72. The method of embodiment 68, further comprising: receiving, from the person, a country name, wherein the mapping includes inference based on the country name.

Embodiment 73. A computerized method of enrolling a person in a database, the method comprising: recording speech audio; recognizing a plurality of possible phoneme sequences from the speech recording; presenting to the person a menu of pronunciations, each pronunciation corresponding to one of the plurality of possible phoneme sequences; accepting a choice from the person; and storing, in a database, the lexical text entry and the pronunciation keyed to a person ID, wherein the stored pronunciation is the phoneme sequence chosen by the person.

Embodiments 74-102 Below Relate to Delivering a Message with Personalized Name Pronunciation.

Embodiment 74. A computerized method for delivering a message with personalized name pronunciation, the method comprising: obtaining at least a portion of a script, the portion of the script comprising a lexical text segment to be converted to speech and a name placeholder; obtaining a person ID, the person ID associated with a person having a name; accessing a database using the person ID to obtain pronunciation information for the name, the database including both the pronunciation information and a lexical representation of the name, different than the pronunciation information, linked to the person ID; synthesizing speech representing the lexical text of the portion of the script; generating an audio name based on the pronunciation information; and delivering the speech and the audio name to at least one individual as audio.

Embodiment 75. The method of embodiment 74, further comprising synthesizing the audio name based on a phonetic text representation of the name, wherein the pronunciation information comprises the phonetic text representation of the name.

Embodiment 76. The method of embodiment 75, wherein the phonetic text representation of the name utilizes the international phonetic alphabet or the CMU English phoneme codes.

Embodiment 77. The method of embodiment 75, wherein the phonetic text representation of the name is encoded with a language-independent alphabet.

Embodiment 78. The method of embodiment 74, wherein the pronunciation information comprises a recording of a spoken name.

Embodiment 79. The method of embodiment 74, wherein the pronunciation information was specified by the person associated with the person ID.

Embodiment 80. The method of embodiment 74, further comprising: obtaining a pronunciation hint associated with the person; and selecting a phonetic model for the synthesizing of the speech and/or the generation of the audio name based on the language preference; wherein the pronunciation hint is selected from a group consisting of a country name, an ethnic group, a religious preference, a gender, and a language.

Embodiment 81. The method of embodiment 74, further comprising: receiving a registration request from the person; associating the person with the person ID; receiving the lexical representation of the name from the person; presenting the person with a plurality of choices for pronunciation of the name; receiving a selection of one of the plurality of choices for the pronunciation of the name from the person; creating the pronunciation information from the selected one of the plurality of choices for the pronunciation of the name; and storing the pronunciation information and the lexical representation of the name associated with the person ID in the database.

Embodiment 82. A non-transitory computer-readable storage medium storing instructions which, when executed by at least one processor, program the at least one processor to perform the method of any one of embodiments 74 through embodiment 81.

Embodiment 83. A computerized system for delivering a message with personalized name pronunciation for a person associated with a person ID, the system comprising: a database interface configured to access a database that stores a plurality of records, a record of the plurality of records including fields for the person ID, a lexical representation of a name of the person, and pronunciation information for the name, wherein the record is retrieved from the database by the database interface using the person ID; a message generation module configured to obtain at least a portion of a script and the person ID associated with the person for whom the message is personalized, the portion of the script comprising a lexical text segment to be converted to speech and a name placeholder; a speech synthesizer configured to: obtain pronunciation information for the name and the lexical representation of the name, different than the pronunciation information, from the database interface in response to providing the person ID to the database interface; synthesize speech representing the lexical text of the portion of the script; and generate an audio name based on the pronunciation information; and a client device interface configured to deliver the speech and the audio name to at the person as audio.

Embodiment 84. The system of embodiment 83, wherein the speech synthesizer is further configured to synthesize the audio name based on a phonetic text representation of the name, wherein the pronunciation information comprises the phonetic text representation of the name.

Embodiment 85. The system of embodiment 84, wherein the phonetic text representation of the name utilizes the international phonetic alphabet or the CMU English phoneme codes.

Embodiment 86. The system of embodiment 84, wherein the phonetic text representation of the name is encoded with a language-independent alphabet.

Embodiment 87. The system of embodiment 83, wherein the pronunciation information comprises a recording of a spoken name.

Embodiment 88. The system of embodiment 83, wherein the pronunciation information was specified by the person associated with the person ID.

Embodiment 89. The system of embodiment 83, wherein the system comprises a computerized public address system.

Embodiment 90. The system of embodiment 83, wherein the system comprises an interactive voice response system.

Embodiment 91. The system of embodiment 90, wherein the person ID is obtained based on an account login to the interactive voice response system.

Embodiment 92. The system of embodiment 91, further comprising an authentication module configured to perform an authentication in compliance with the US Health Insurance Portability and Accountability Act to create an account login for the interactive voice response system.

Embodiment 93. A computerized public address system comprising: a database interface enabled to read, from a person information database, a name pronunciation keyed to a person ID; an operator interface allowing an operator to make an automated announcement by selecting: the person ID from a filtered list of database records; and an announcement stored as lexical text having a name placeholder; a speech synthesizer to create audio with the name pronunciation of the person ID in the place of the name placeholder; and an output enabled to send the audio to a loudspeaker, wherein the name pronunciation was specified by a person identified by the person ID.

Embodiment 94. The system of embodiment 93, wherein the name pronunciation is a speech recording.

Embodiment 95. The system of embodiment 93, wherein the name pronunciation is phonetic text.

Embodiment 96. The system of embodiment 95, wherein the phonetic text is encoded with a language-independent alphabet.

Embodiment 97. The system of embodiment 93, further comprising: an administrator interface allowing a system administrator to define announcements as lexical text having placeholders for person names.

Embodiment 98. A computerized method of providing self-service by speech, the method comprising: receiving a request associated with a person ID; reading, from a person information database, a name pronunciation keyed to the person ID; reading, from a script, a sentence having a name placeholder; synthesizing speech audio corresponding to the sentence with the name pronunciation in the place of the name placeholder; and outputting the synthesized speech audio, wherein the name pronunciation was specified by a person identified by the person ID.

Embodiment 99. The method of embodiment 98, wherein the name pronunciation is phonetic text.

Embodiment 100. The method of embodiment 99, wherein the phonetic text is encoded with a language-independent alphabet.

Embodiment 101. The method of embodiment 98, further comprising: identifying a language preference; and conditioning the phonetic model of the speech synthesis on the choice of language preference.

Embodiment 102. The method of embodiment 99, further comprising, before receiving a request associated with a person ID, performing an authentication in compliance with the US Health Insurance Portability and Accountability Act. Examples shown and described use certain spoken languages. Various embodiments operate, similarly, for other languages or combinations of languages.

Unless otherwise indicated, all numbers expressing quantities, properties, measurements, and so forth, used in the specification and claims are to be understood as being modified in all instances by the term “about.” The recitation of numerical ranges by endpoints includes all numbers subsumed within that range, including the endpoints (e.g. 1 to 5 includes 1, 2.78, 7C, 3.3̅3̅, 4, and 5).

As used in this specification and the appended claims, the singular forms “a”, “an”, and “the” include plural referents unless the content clearly dictates otherwise. Furthermore, as used in this specification and the appended claims, the term “or” is generally employed in its sense including “and/or” unless the content clearly dictates otherwise. As used herein, the term “coupled” includes direct and indirect connections. Moreover, where first and second devices are coupled, intervening devices including active devices may be located there between.

The description of the various embodiments provided above is illustrative in nature and is not intended to limit this disclosure, its application, or uses. Thus, different variations beyond those described herein are intended to be within the scope of embodiments. Such variations are not to be regarded as a departure from the intended scope of this disclosure. As such, the breadth and scope of the present disclosure should not be limited by the above-described exemplary embodiments, but should be defined only in accordance with the following claims and equivalents thereof.

What is claimed is:

1. A computerized method for personalizing a name pronunciation, the method comprising:
receiving a request from a client device used by a person;
associating the person with a person ID;
obtaining a lexical representation of a name of the person;
creating pronunciation information for the name of the person, different than the lexical representation of the name, based on an input from the person to the client device; and
storing the pronunciation information with the lexical representation of the name associated with the person ID in a database.

2. The method of claim 1, wherein the request initiates creation of a new record for the person in the database, a new person ID is generated as the person ID in response to the request, and the lexical representation of the name of the person is provided by the person.

3. The method of claim 1, wherein the request initiates an update of a record for the person in the database, and the person ID and the lexical representation of the name of the person are retrieved from the database.

4. The method of claim 1, wherein the pronunciation information comprises phonetic text.

5. The method of claim 4, wherein the phonetic text is encoded with a language-independent alphabet.

6. The method of claim 1, further comprising:
receiving a speech recording from the client device, wherein the input from the person to the client device comprises the speech recording; and
using the speech recording as the pronunciation information.

7. The method of claim 1, further comprising:
receiving a speech recording from the client device, wherein the input from the person to the client device comprises the speech recording;
recognizing a phoneme sequence from the speech recording; and
using the recognized phoneme sequence to create the pronunciation information.

8. The method of claim 7, further comprising:
mapping the lexical representation of the name to a plurality of phoneme sequences; and
determining whether the recognized phoneme sequence matches one of the plurality of phoneme sequences; and
sending an error indication to the client device in response to determining that the recognized phoneme sequence does not match one of the plurality of phoneme sequences.

9. The method of claim 7, further comprising:
mapping the lexical representation of the name to a phoneme sequence;
comparing the phoneme sequence to a list of forbidden phoneme sequences; and
using the phoneme sequence as the pronunciation information in response to determining that the phoneme sequence does not include any words in the list of forbidden words.

10. The method of claim 7, further comprising:
synthesizing speech using the recognized phoneme sequence to create a synthesized audio clip; and
storing the synthesized audio clip as the pronunciation information.

11. The method of claim 1, further comprising:
generating a plurality of choices for pronunciation of the name based on the lexical representation of the name;
sending the plurality of choices for pronunciation of the name to the client device for presentation to the person;
receiving a selection of one of the plurality of choices for the pronunciation of the name from the client device, wherein the received selection represents the input from the person to the client device; and
creating the pronunciation information from the selected one of the plurality of choices for the pronunciation of the name.

12. The method of claim 11, wherein at least one of the plurality of choices for the pronunciation of the name comprises a sound data.

13. The method of claim 11, the method further comprising:
mapping the lexical representation of the name to a plurality of phoneme sequences; and
using the plurality of phoneme sequences to generate the plurality of choices for the pronunciation of the name.

14. The method of claim 13, wherein the mapping uses lexeme to phoneme rules.

15. The method of claim 11, further comprising:
obtaining a pronunciation hint associated with the person; and
using the pronunciation hint with the lexical representation of the name to generate the plurality of choices for the pronunciation of the name.

16. The method of claim 15, wherein the pronunciation hint includes a geographic identifier.

17. The method of claim 15, wherein the pronunciation hint includes a gender.

18. The method of claim 15, wherein the pronunciation hint includes a language.

19. The method of claim 15, wherein the pronunciation hint is retrieved from the database using the person ID.

20. The method of claim 15, wherein the pronunciation hint is provided by the person.

21. The method of claim 1, further comprising performing an authentication in compliance with the US Health Insurance Portability and Accountability Act before receiving the request.

22. The method of claim 1, further comprising:
receiving a message request to provide a message that includes the name of the person associated with the person ID;
obtaining at least a portion of a script, the portion of the script comprising a lexical text segment to be converted to speech and a name placeholder;
accessing the database using the person ID to obtain the pronunciation information for the name;
synthesizing speech representing the lexical text of the portion of the script;
generating an audio representation of the name based on the pronunciation information; and
delivering the speech and the audio representation of the name to at least one individual as audio.

23. A computerized system for personalizing a name pronunciation, the system comprising:
a client device interface configured to communicate with a client device used by a person;
an authentication module configured to accept authentication information received from the client device through the client device interface and determine a person ID for the person;
a database interface configured to access a database that stores a plurality of records, a record of the plurality of records including fields for the person ID, a lexical representation of a name of the person, and pronunciation information for the name; and
a pronunciation module configured to receive an input from the person through the client device interface and create pronunciation information for the name of the person, different than the lexical representation of the name, based on the input from the person, and provide the pronunciation information to the database interface for storage associated with the person ID in the database.

24. A non-transitory computer-readable storage medium storing instructions which, when executed by at least one processor, program the at least one processor to perform a method comprising:
receiving a request from a client device used by a person;
associating the person with a person ID;
obtaining a lexical representation of a name of the person;
creating pronunciation information for the name of the person, different than the lexical representation of the name, based on an input from the person to the client device; and
storing the pronunciation information with the lexical representation of the name associated with the person ID in a database.
